(19) United States
(12) Patent Application Publication
(10) Pub. No.: US 2026/0287383 A1
(43) Pub. Date: Sep. 24, 2026

(54) Assistive Technology for Low Vision and Alternate Sensory Input

(71) Applicant: Daniel Lahey, Mio, MI (US)

(72) Inventor: Daniel LAHEY, Mio, MI (US)

(21) Appl. No.: 19/577,247

(22) Filed: Mar. 24, 2026

Related U.S. Application Data
(60) Provisional application No. 63/776,666, filed on Mar. 24, 2025.

(51) Int. Cl. G01C 21/36; G09B 21/00

(52) U.S. Cl. CPC G01C 21/3652; G09B 21/003

(57) ABSTRACT

Method and systems for providing haptic feedback for navigation assistance to a visually impaired user include initializing a plurality of distance sensors, the plurality of distance sensors comprising ultrasonic sensors and an infrared (IR) sensor, and detecting motion of the visually impaired user via a motion detection sensor operatively connected to the computing system. In response to detecting motion of the visually impaired user, the system may activate a plurality of distance sensors to measure distances to one or more obstacles in an environment. The system may generate distance data for each of the plurality of distance sensors based on measured distances and determine vibration intensities for the plurality of vibrating motors based on the distance data. The system may activate each vibrating motor to generate a haptic feedback output to the visually impaired user based on the corresponding determined vibration intensity

### RELATED APPLICATIONS

This application claims the benefit of priority to U.S. Provisional Patent Application No. 63/776,666 entitled “Assistive Technology for Low Vision and Alternate Sensory Input” filed on Mar. 24, 2025, the entire contents of which are hereby incorporated by reference for all purposes.

### BACKGROUND

A significant percentage of the world's population has visual impairments. Some technological advances emerged in recent years to assist visually impaired individuals, but few solutions address the replacement or supplement of a cane for object detection and localization. Few solutions exist for low vision individuals to identify objects, words, or faces.

Devices that operate on alternate sensory input may empower people with disabilities to conduct daily tasks such as navigation, transportation, and interaction with the environment. Alternate sensory input devices also may serve commercial uses that supplement or enhance sensory perception in consumers. A demand exists for advanced real-time processing devices and systems that operate alternate sensing technology seamlessly and assist individuals, disabled or otherwise, in navigating dynamic settings.

### SUMMARY OF THE DISCLOSURE

The embodiments include methods for providing haptic feedback for navigation assistance to a visually impaired user, the methods performed by a computing system having one or more processors, one or more memories, and a plurality of sensors, the methods including: (a) initializing a plurality of distance sensors, the plurality of distance sensors including ultrasonic sensors and an infrared (IR) sensor; (b) detecting motion of the visually impaired user via a motion detection sensor operatively connected to the computing system; (c) upon detecting motion of the visually impaired user, activating the plurality of distance sensors to measure distances to one or more obstacles in an environment; (d) generating distance data for each of the plurality of distance sensors based on the measured distances; (e) determining a vibration intensity for a plurality of vibrating motors based on the distance data, in which the vibration intensity increases as the measured distance decreases; and (f) activating each vibrating motor to generate a haptic feedback output to the visually impaired user based on the corresponding determined vibration intensity.

Some embodiments may further include a method including (a) deactivating the plurality of distance sensors and the plurality of vibrating motors when no motion is detected for a predefined period; and (b) reactivating the plurality of distance sensors and the plurality of vibrating motors upon detecting resumption of motion by the visually impaired user.

Some embodiments may further include a method in which generating distance data including (a) calculating a distance to each detected obstacle using ultrasonic pulses emitted by the ultrasonic sensors; and (b) calculating a distance to a hand-positioned obstacle using the infrared sensor.

Some embodiments may include a method in which determining the vibration intensity includes applying a predefined function to the distance data, in which the vibration intensity is calculated as a function of the measured distance to the obstacle and a maximum vibration threshold.

Some embodiments may include a method in which each sensor of the plurality of distance sensors is mapped to a corresponding vibrating motor, such that each vibrating motor provides haptic feedback based on the distance data from the corresponding sensor.

Some embodiments may include a method including (a) identifying an obstacle within a critical distance threshold; and (b) triggering a maximum vibration intensity output when the obstacle is within the critical distance threshold.

Some embodiments may include a method further including (a) performing a calibration procedure to optimize sensitivity of the plurality of distance sensors based on real-world testing; and (b) storing calibration data to improve future distance measurement accuracy.

Some embodiments may include a method further including (a) adjusting the vibration intensity based on feedback provided by the visually impaired user, in which the feedback modifies a sensitivity parameter used in determining vibration intensity.

In some embodiments, a method for filtering environmental interference from distance sensor measurements in an assistive system may be performed by a computing/processing system having one or more processors and one or more memories. The method may include collecting distance measurements from a distance sensor pointing in a given direction and storing the distance measurements from a predefined time period as a function of time in a dataset. The method may further include extrapolating the dataset to generate a predicted measurement value and receiving a new distance measurement from the distance sensor. The method may include comparing the new distance measurement to the predicted measurement value and determining whether a deviation between the new distance measurement and the predicted measurement value exceeds a threshold value. In response to determining the deviation does not exceed the threshold value, the method may include adding the new distance measurement to the dataset and communicating the new distance measurement to a user. In response to determining the deviation exceeds the threshold value, the method may include discarding the new distance measurement and communicating a most recent valid measurement to the user.

In some embodiments, a method for filtering environmental interference from distance sensor measurements in an assistive system using dual distance sensors may be performed by a computing system having one or more processors and one or more memories. The method may include collecting distance measurements from a first distance sensor and a second distance sensor mounted close together and pointing in a same direction. The method may further include storing the distance measurements from the first distance sensor in a first dataset and storing the distance measurements from the second distance sensor in a second dataset. The method may include extrapolating the first dataset to generate a first predicted measurement value and extrapolating the second dataset to generate a second predicted measurement value. The method may further include receiving a first new distance measurement from the first distance sensor and a second new distance measurement from the second distance sensor. The method may include calculating a first combined average of the second new distance measurement, the second predicted measurement value, and the first predicted measurement value, and calculating a second combined average of the first new distance measurement, the second predicted measurement value, and the first predicted measurement value. The method may further include comparing the first new distance measurement to the first combined average and comparing the second new distance measurement to the second combined average to determine validity of each measurement, and communicating distance information to the user based on the validity determination.

### BRIEF DESCRIPTION OF THE DRAWINGS

FIG. 1 is a schematic diagram illustrating an assistive system, according to an embodiment.

FIG. 2A is an example sensing element that may be a part of an assistive system, according to an embodiment.

FIG. 2B is an example of an alerting element that may be a part of an assistive system, according to an embodiment.

FIG. 3 is a schematic diagram illustrating an assistive system, according to an embodiment.

FIGS. 4A, 4B, and 4C are schematics depicting a side view, a front view, and a back view of a user, respectively, indicating placement of sensors and/or motors in an assistive system, according to an embodiment.

FIGS. 5A, 5B, and 5C are schematic representations of a front view, a perspective view, and a back view of example supporting elements in the form of garments, as worn by a user, to house or support an assistive system, according to an embodiment.

FIG. 6 is an exemplary snippet of code representing instructions to implement a functionality of an assistive system, according to an embodiment.

FIG. 7A is an exemplary snippet of code representing instructions to implement a functionality of an assistive system, according to an embodiment.

FIG. 7B is an exemplary snippet of code representing instructions to implement a functionality of an assistive system, according to an embodiment.

FIGS. 8A-8D are exemplary snippets of code representing instructions to implement the functionality of an assistive system, according to an embodiment.

FIGS. 9A-9C show schematics illustrating orthogonal views of a hand of a user wearing an assistive system, according to some embodiments. FIGS. 9A-9C show an exemplary arrangement and placement of sensing/alerting elements, according to some embodiments.

FIGS. 10A-10C show schematics illustrating orthogonal views of a hand of a user wearing an assistive system, according to some embodiments. FIGS. 10A-10C show an exemplary arrangement and placement of sensing/alerting elements, according to some embodiments.

FIG. 11 is a flow diagram illustrating a method of using an assistive system for providing navigation assistance to a user, according to an embodiment.

FIG. 12 is a flow diagram illustrating a method of using an assistive system for providing haptic feedback for navigation assistance to a visually impaired user, according to an embodiment.

FIGS. 13 and 14 are process flow diagrams illustrating methods of using an assistive system, according to an embodiment.

FIGS. 15 and 16 are process flow diagrams illustrating methods of using an assistive system, according to an embodiment.

FIGS. 17A-17E are diagrams illustrating exemplary code that may be used to implement an assistive system in accordance with some embodiments.

FIGS. 18A-18C are diagrams illustrating additional exemplary code that may be used to implement an assistive system in accordance with some embodiments.

FIGS. 19A and 19B are diagrams illustrating additional exemplary code that may be used to implement an assistive system in accordance with some embodiments.

FIGS. 20A and 20B are diagrams illustrating additional exemplary code that may be used to implement an assistive system in accordance with some embodiments.

FIGS. 21A and 21B are diagrams illustrating additional exemplary code that may be used to implement an assistive system in accordance with some embodiments.

FIGS. 22A-22C are diagrams illustrating additional exemplary code that may be used to implement an assistive system in accordance with some embodiments.

FIGS. 23A-23C are diagrams illustrating additional exemplary code that may be used to implement an assistive system in accordance with some embodiments.

FIGS. 24A-24D are diagrams illustrating additional exemplary code that may be used to implement an assistive system in accordance with some embodiments.

FIGS. 25A and 25B are diagrams illustrating additional exemplary code that may be used to implement an assistive system in accordance with some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

The word “exemplary” may be used herein to mean “serving as an example, instance, or illustration”. Any implementation described herein as “exemplary” is not necessarily to be construed as preferred or advantageous over other implementations.

The various embodiments include methods and systems that implement an assistive system to receive and assimilate alternate sensory input to aid individuals who are sensorily disabled or to enhance the sensory abilities of individuals who are able-bodied. Some embodiments include methods and systems to provide haptic feedback for navigation assistance to a visually impaired user. Some embodiments may be performed by a computing system having a processing system having one or more processors, one or more memories, one or more sensing elements, and one or more alerting elements. In some embodiments, the assistive system may include a supporting element, a power source, one or more processors coupled to the one or more sensing elements and to the one or more alerting elements. The sensing elements may be selected and/or configured to receive alternate sensory input from an alternative modality than generally used by humans, and the alerting elements are selected and/or configured to produce an alert or signal that may be perceived by the user. The alerting element may be configured to signal using any suitable modality and change the signaling as a function of the sensing by the sensing element.

The term “processing system” may be used herein to refer to one or more processors, including multiple processors or multiple microprocessors that are organized and configured to perform various computing functions. Various embodiment methods may be implemented in one or more of multiple processors within a processing system of a computing device, as described herein.

The term “sensor” may be used herein to refer to a device that acquires information about a target. Sensors may include non-contact sensors and contact sensors. A “non-contact sensor” may be a sensor that detects one or more target characteristics without physical contact with the target. The one or more target characteristics may include presence, location, distance, temperature, shape, color, material, or another detectable property. A “contact sensor” may be a sensor that acquires one or more target characteristics through physical contact with the target. The target may include a solid, liquid, or gas. An “image-processing camera” may be a vision sensor that captures image data and processes the image data to identify one or more visual features, such as text, color, shape, object identity, facial features, or animal features.

The term “haptic output” may be used herein to refer to tactile communication through vibration, pressure, motion, or another tactile stimulus.

The embodiments include one or more proximity sensors, one or more contact sensors, one or more image-processing cameras, or a combination thereof that provide input data, and one or more alerting elements that provide haptic output, audio output, pressure output, thermal output, light output, or another output modality to communicate information to a user.

Sensors generally fall into two different types. A proximity sensor is any device that detects the presence, location, distance, temperature, shape, color, including material, or any other characteristic of an object (referred to as a target) without physically touching the target. A contact sensor that must physically touch a target, whether solid, liquid, or gaseous, in order to detect the distance, temperature, shape, color, including material, or any other characteristic of said target. Haptic feedback, also known as haptics, is the practice of using vibrations to provide tactile feedback to communicate information or simulate tactile experiences. An image processing camera is a fast vision sensor that captures image data and processes it to identify specific colors and shapes. It may be applied for many applications, including reading text, identifying and recognizing objects, and recognizing and identifying specific individuals or pets.

The various embodiments address the unmet needs of visually impaired and low vision individuals by using proximity and/or contact sensors and/or image processing cameras in concert with haptics, sounds, pressure, and other sensory inputs to communicate environmental information and other information. This has applications for individuals with low vision and/or military personnel.

The disclosure relates to assistive technology for low vision, useful for object detection and avoidance, navigating difficult or varied terrains, reading, object recognition, face recognition, and other assistive services useful to visually impaired individuals or individuals with impairments to hearing, balance, smell, proprioception, and/or taste. The disclosure also relates to the use of haptics, sounds, pressure, and other sensory inputs to communicate environmental information and other information to low vision individuals and/or military personnel.

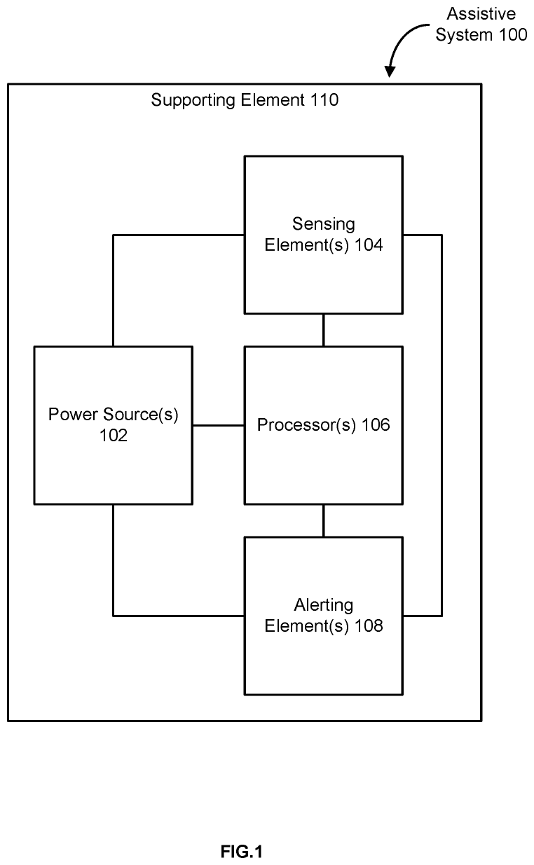

FIG. 1 illustrates a block diagram of an exemplary assistive system 100, according to an embodiment. As shown, assistive system 100 may include one or more power sources 102, one or more sensing elements 104, one or more processors 106, one or more alerting elements 108, and a supporting element 110. The sensing element(s) 104, processor(s) 106, and alerting element(s) 108 may be operatively coupled to communicate with one another through wired links, wireless links, or both. In some embodiments, one or more sensing element(s) 104 may be coupled to one or more alerting element(s) 108 through one or more processor(s) 106 in a closed-loop configuration. In some embodiments, one or more components of system 100 may be enclosed partially or fully within a housing having a selected size, weight, flexibility, or rigidity. In some embodiments, sensing element(s) 104, processor(s) 106, and/or alerting element(s) 108 may communicate with one or more external data sources or computing devices not shown in FIG. 1, such as a remote data system, a mobile phone, a computer, a smartwatch, a health monitor, a smart ring, or another user device.

Supporting element 110 may serve as a mounting surface, frame, support, holder, or housing for components in system 100. In some embodiments, system 100 may be a wearable system, and supporting element 110 may include a wearable device, object, garment, or accessory. By way of example, supporting element 110 may include a suit, a headband, an armband, a band worn on a user's body, a shirt, pants, a belt, a hat, a cap, glasses, or another garment worn by a user. In some embodiments, supporting element 110 may include one or more objects or portions of one or more objects used by a user or subject. By way of example, supporting element 110 may include one or more bicycle helmets, electric bicycle helmets, motorcycle helmets, ATV helmets, bicycles, electric bicycles, motorcycles, vehicles, automobiles, ATVs, or similar articles.

Returning to FIG. 1, power source(s) 102 may include one or more power sources operatively coupled to power sensing element(s) 104, processor(s) 106, and alerting element(s) 108. In some embodiments, a single centrally located power source 102 may power one or more sensing element(s) 104, processor(s) 106, and alerting element(s) 108. In some embodiments, one or more power source(s) 102 may be positioned locally near individual sensing element(s) 104, processor(s) 106, alerting element(s) 108, or groups thereof.

In some embodiments, power source(s) 102 may be selected and/or configured to support low power consumption during extended operation. In some embodiments, power source(s) 102 may be selected and/or configured based on one or more parameters associated with a selected user or use case. By way of example, such parameters may include size, weight, heat generation, heat dissipation, output power level, durability, installation cost, maintenance cost, replaceability, rechargeability, capacity to store power, capacity to deliver power, ease of activation, ease of deactivation, form factor, comfort, conformability to supporting element 110, ease of connection, or body position. In some embodiments, power source(s) 102 may be selected and/or configured based on one or more environmental or operational conditions, such as water resistance, thermal susceptibility, or impact resistance. By way of example, power source(s) 102 may include disposable battery packs, rechargeable batteries, wired charging interfaces, wireless charging interfaces, or combinations thereof.

Sensing element(s) 104 in system 100 may include one or more devices configured to sense distance from the location of the sensing element to an object along an identified path. Sensing element(s) 104 may include one or more ultrasonic sensors, infrared sensors, laser sensors, proximity sensors, or other distance sensors. Selection and configuration of sensing element(s) 104 may be based on one or more parameters, such as sensing range, sensing angle, target distance range for a selected use case, sensed modality, ease of integration into system 100, installation cost, maintenance cost, durability, power consumption, ability to operate through intervening materials, accuracy, precision, resistance to environmental interference, suitability for real-time processing, replaceability, repairability, form factor, comfort, conformability to supporting element 110, ease of electrical or mechanical coupling, or body position. In some embodiments, sensing element(s) 104 may adapt an emitted signal parameter, such as pulse timing or transmission frequency, in response to detected interference. Sensing may occur continuously or in intermittent pulses over predefined time intervals. In some embodiments, pulse rate may vary dynamically, such as by increasing as measured distance decreases.

In some embodiments, one or more sensing element(s) 104 may be manually adjustable in one or more parameters, such as sensing angle, amplitude range, maximum range, or minimum range.

In some embodiments, sensing element(s) 104 may be selected and/or configured based on low power consumption and user comfort during extended wear. In some embodiments, sensing element(s) 104 may be selected and/or configured to satisfy parameters associated with a selected use case, such as water resistance or impact resistance. In some embodiments, relevant parameters may include size, weight, heat generation, heat dissipation, comfort, and user preference.

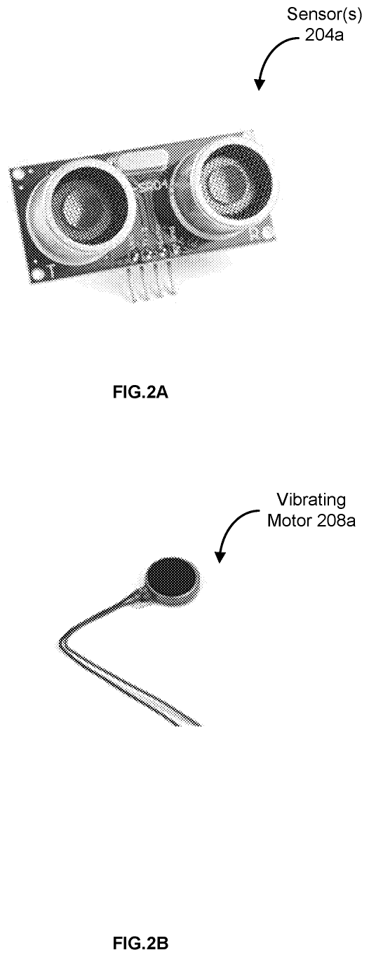

FIG. 2A is an image of an exemplary sensing element sensor 204a configured to be part of a system, according to an embodiment. The sensor 204a may be substantially similar in structure and/or function to the sensing element 204 described herein, with reference to the system 100 in FIG. 1. The sensor 204a includes a commercially available ultrasonic sensor from vendor Adafruit (Ultrasonic Distance Sensor—3V or 5V—HC-SR04 compatible—RCWL-1601 Product ID: 4007). As described by its vendor, the sensor 204a may sense distances between approximately 1 cm to approximately 400 cm. The sensor 204a operates using a power and logic voltage of DC 5V and shows a current during measurement of approximately 15 mA. It transmits ultrasonic frequency of 40 KHz and receives bounced back signals of the emitted ultrasonic frequency of 40 KHz to aid in distance measurement. It has a measuring or sensing angle of approximately 15°. It may be triggered with a trigger input signal of approximately 10 uS high pulse. The sensor's dimensions (excluding header) are approximately 45.5×20×15.5 mm and it weighs about 8.7 g. In some embodiments, the ultrasonic sensor 204a may be chosen for identified positions on the user's body based on the distance to be sensed, ease of integration, and price point.

Another example sensing element may be an IR distance sensor configured to sense and measure distances from approximately 20 cm to approximately 150 cm. As an example, IR sensor sold by vendor Adafruit (IR distance sensor includes cable (20 cm-150 cm)—Model No. GP2Y0A02YK) may be used to be positioned on the body of a user to emit and receive laser signals and use the bounced back laser signals to measure distance from objects. The IR sensor may have dimensions of length of approximately 21.66 mm, width of approximately 44.39 mm, and height of approximately 18.67 mm. It may have a weight of approximately 5 g-8 g. In some embodiments, the IR sensor may be chosen for identified positions on the user's body based on its range, precision, and resistance to interference.

In some embodiments, the sensing element 204a may include a commercially available HC-SR04-compatible ultrasonic distance sensor, such as an ultrasonic distance sensor sold by Adafruit. Such a sensor may transmit ultrasonic pulses and receive reflected ultrasonic pulses to determine distance to an object within a selected field of view. In some embodiments, the ultrasonic sensor may be selected for a body location based on target sensing range, field of view, ease of integration, form factor, power consumption, or cost.

In some embodiments, the sensing element 204a may include an infrared distance sensor configured to measure distance within a short-range interval suitable for wearable navigation assistance. By way of example, an infrared distance sensor, such as a commercially available GP2Y0A02YK sensor, may emit infrared energy, receive reflected infrared energy, and generate an output representative of distance to an object. In some embodiments, the infrared sensor may be positioned on a user's body based on range, precision, field of view, resistance to selected sources of interference, form factor, or ease of integration.

Returning to system 100 in FIG. 1, alerting element(s) 108 may include one or more devices, effectors, or actuators configured to generate an output perceivable by a user through a selected sensory modality, such as sound, tactile stimulation, thermal stimulation, pressure, or light. In some embodiments, alerting element(s) 108 may include vibrating motors configured to generate vibrations in response to a control signal. In some embodiments, alerting element(s) 108 may include one or more eccentric rotating mass motors, linear resonant actuators, voice-coil actuators, piezoelectric actuators, pneumatic actuators, speakers, thermal effectors, or other output devices.

The output generated by alerting element(s) 108 may have one or more selected parameters, such as frequency, amplitude, duty cycle, interval, waveform, or another signal parameter, to provide a perceivable sensation to a user. Selection of output modality for alerting element(s) 108 may be based on one or more needs, sensitivities, or preferences of the user.

In some embodiments, alerting element(s) 108 may include one or more motors selected and/or configured to deliver a dynamically variable haptic sensation or audio sensation that maps to measured distance. By way of example, one or more motors may vary intensity, frequency, duty cycle, or another output parameter as a function of measured distance. In some embodiments, alerting element(s) 108 may be selected and/or configured based on output range, amplitude, frequency, accuracy, precision, response time, ability to change dynamically in real time, output modality, or user comfort.

In some embodiments, alerting element(s) 108 may be selected and/or configured based on ease of integration into system 100, installation cost, maintenance cost, durability, power consumption, continuous operating capability, ability to produce a perceivable output through intervening materials such as clothing, replaceability, repairability, form factor, comfort, conformability to supporting element 110, ease of connection, or placement on the user.

In some embodiments, alerting element(s) 108 may be selected and/or configured based on low power consumption and user comfort during extended wear. In some embodiments, alerting element(s) 108 may be selected and/or configured to satisfy parameters associated with a selected use case, such as water resistance or impact resistance. In some embodiments, relevant parameters may include size, weight, heat generation, heat dissipation, and user preference. In some embodiments, alerting element(s) 108 may be selected and/or configured to avoid output ranges that are imperceptible to the user or undesirable to the user.

FIG. 2B shows an image of an exemplary alerting element that is a vibrating motor 208a, to be used in a system, according to an embodiment. The vibrating motor 208a may be substantially similar in structure and/or function to the alerting element 108 described herein with reference to the system 100 in FIG. 1. The vibrating element 208a is a commercially available vibrating mini motor disc sold by vendor Adafruit (Vibrating Mini Motor Disc Product ID: 1201 MODEL: 10B27.3018). the vibrating motor 208a has dimension of approximately 10 mm diameter and 2.7 mm thickness. It operates using a voltage signal ranging from 2V to 5V, with a current draw of approximately 100 mA at 5V, 80 mA at 4V, 60 mA at 3V, and 40 mA at 2V. It is configured to generate a vibratory signal of 11000 RPM at 5V. The vibrating motor 208a has a weight of approximately 0.9 gram. In some embodiments, the vibrating motor 208a may be chosen for its form factor, light weight, low power draw, and/or dynamically variable output control.

In some embodiments, the alerting element 208a may include a commercially available miniature disc motor, such as a miniature disc motor sold by Adafruit, configured to generate vibration in response to an applied voltage or a pulse-width modulation control signal. In some embodiments, the vibrating motor may be selected based on form factor, weight, power consumption, output controllability, or ease of integration.

Returning to system 100 in FIG. 1, processor(s) 106 may include one or more processors operatively coupled to sensing element(s) 104 and alerting element(s) 108 to receive signals from sensing element(s) 104, calculate distance to a detected obstacle or object based on the received signals, and generate one or more control signals for alerting element(s) 108 to produce an output perceivable by the user. In some embodiments, processor(s) 106 may be positioned locally near individual sensing element(s) 104 and/or alerting element(s) 108. In some embodiments, processor(s) 106 may be positioned locally near groups of sensing element(s) 104 and/or alerting element(s) 108, such as one processor for three paired sensing and alerting elements or one processor for nine paired sensing and alerting elements.

Processor(s) 106 may be operatively coupled to one or more sensing element(s) 104 and/or one or more alerting element(s) 108 through wired connections, wireless connections, or both. In some embodiments, processor(s) 106 may be implemented using one or more microcontrollers or other processing units.

Processor(s) 106 may be configured to perform one or more processing operations on data received from sensing element(s) 104. The processing operations may include averaging, smoothing, filtering, measuring changes over time, calculating deviations, comparing measurements to one or more threshold values, or other signal-processing operations. In some embodiments, filtering may include one or more low-pass filters, band-pass filters, matched filters, or other filters selected for a particular use case.

Processor(s) 106 may be configured to calculate distance data in real time as a user moves through space. Processor(s) 106 may further be configured to adjust one or more vibration parameters, such as intensity, amplitude, frequency, or duty cycle, of alerting element(s) 108 as a function of measured distance. In some embodiments, processor(s) 106 may apply a predefined function to distance data such that vibration intensity and/or vibration frequency of one or more alerting element(s) 108 varies as a function of measured distance and an upper output threshold.

In some embodiments, processor(s) 106 may be operatively coupled to selected sensing element(s) 104 and selected alerting element(s) 108. In some embodiments, one processor 106 from a plurality of processors may be configured such that each sensing element from a plurality of sensing element(s) 104 is mapped to a corresponding alerting element from a plurality of alerting element(s) 108. In such embodiments, each alerting element may provide haptic feedback based on distance data from the corresponding sensing element and processing performed by the corresponding processor. By way of example, sensing element(s) 104 may detect obstacles and generate distance information, processor(s) 106 may convert the distance information into one or more output-control parameters, and alerting element(s) 108 may generate sensory feedback based on the output-control parameters.

In some embodiments, the processor(s) 106 may be configured to implement an automatic activation and deactivation mode. In some embodiments, the processor(s) 106 may be configured to deactivate one or more alerting element(s) 108 at identified conditions (e.g., signals from a sensing element(s) 104 below a predefined threshold value indicating no motion being detected). The alerting element(s) 108 may be maintained to be shut off or deactivated by default (e.g., to conserve power, to increase user friendliness, or to reduce stray signals to the user, etc.) unless activated by a processor 106. The Processor(s) 106 may be configured to send a signal, for example a deactivation signal, to the one or more alerting element(s) 108 to maintain the one or more alerting element(s) 108 in a deactivated state for a predefined period. The alerting element(s) 108 may be activated based on a signal e.g. an activation signal, from the processor(s) 106 to activate the alerting element 108. The processor(s) 106 may be configured to monitor signals received by identified sensing element(s) 104 grouped with an alerting element 108, and when the signals from the identified sensing element(s) 104 meet a threshold. For example, a change in signal amplitude over a predefined time period may be used to measure a change in distance and if it exceeded a certain absolute magnitude threshold (e.g., 3 mm), the deviation in signal may be considered significant to send an activation signal to one or more alerting element(s) 108 to power them on. The threshold value may be experimentally determined for different environments. The length of the predefined period over which to obtain samples by the sensing element(s) 104 may be empirically determined.

In some embodiments, processor(s) 106 may be configured to implement an automatic activation mode and an automatic deactivation mode. In some embodiments, processor(s) 106 may deactivate one or more alerting element(s) 108 under identified conditions, such as when one or more motion-related signals indicate that the user has remained stationary for at least a predefined period. In some embodiments, one or more alerting element(s) 108 may remain in a deactivated state by default until activated by processor(s) 106. Processor(s) 106 may send a deactivation signal to maintain one or more alerting element(s) 108 in the deactivated state and may send an activation signal to activate one or more alerting element(s) 108. In some embodiments, processor(s) 106 may monitor signals from one or more motion detection sensors and/or one or more grouped sensing element(s) 104 and may activate one or more alerting element(s) 108 when the monitored signals satisfy a threshold. By way of example, a change in a measured parameter over a predefined time period may indicate motion, and if the change exceeds an absolute threshold, processor(s) 106 may send an activation signal. In some embodiments, threshold values and sampling periods may be established empirically for different environments.

In some embodiments, processor(s) 106 may perform one or more preparatory operations on signals received from sensing element(s) 104 before distance

In some embodiments, the one or more processor(s) 106 may be configured to perform operation on signals received by the one or more sensing element(s) 104 to prepare the signals for calculation of distance. For example, the processor(s) 106 may be configured to conduct calibration of one or more sensing element(s) 104 and/or alerting element(s), measure a signal-to-noise ratio SNR associated with one or more sensing element(s) 104 to determine proper functioning, to activate re-calibration if the SNR dropped below a desired threshold, and/or the like. In some implementations, the system 100 may be configured to run self-calibration of each component at intermittent intervals or when in known environments, etc.

In some embodiments, processor(s) 106 may perform one or more preparatory operations on signals received from sensing element(s) 104 before distance calculation. By way of example, processor(s) 106 may perform calibration of one or more sensing element(s) 104 and/or alerting element(s) 108, measure a signal-to-noise ratio (SNR) associated with one or more sensing element(s) 104 to assess functionality, and initiate recalibration if the SNR falls below a selected threshold. In some implementations, system 100 may perform self-calibration at intermittent intervals or in one or more known environments.

In some embodiments, processor(s) 106 may implement one or more learning algorithms such that predefined patterns of input from one or more sensing element(s) 104 may be used to identify a complex or three-dimensional shape or structure of one or more objects, such as a chair, a doorframe, a set of stairs, or a handrail. In some embodiments, processor(s) 106 may implement one or more learning algorithms such that predefined patterns of input from one or more sensing element(s) 104 may be used to identify familiar objects or familiar paths in familiar environments. In some embodiments, system 100 may perform higher-order processing to predict shape or form, detect selected environmental conditions, categorize objects as mobile or fixed, track mobile objects, or perform related operations.

In some embodiments, the processor(s) 106 may be implemented using one or more microprocessing units (e.g., microcontrollers such as an Arduino board or Arduino Mega used to interpret the signals from the distance sensors and activate the haptic feedback motors in the main body unit).

In some embodiments, the system 100 may be used to implement a method for providing haptic feedback for navigation assistance to a visually impaired user. The method may be performed by a computing system having a processor (e.g., processors 106), a memory, one or more sensors (e.g., sensing elements 104), and one or more motors (e.g., alerting elements 108). The method may include: (a) initializing a plurality of distance sensors (e.g., sensing elements 104), the plurality of distance sensors including ultrasonic sensors and an infrared (IR) sensor; (b) detecting motion of the visually impaired user via a motion detection sensor operatively connected to the computing system; (c) upon detecting motion of the visually impaired user, activating the plurality of distance sensors to measure distances to one or more obstacles in an environment; (d) generating distance data for each of the plurality of distance sensors based on the measured distances; (e) determining a vibration intensity for a plurality of vibrating motors based on the distance data, in which the vibration intensity increases as the measured distance decreases; and (f) activating each vibrating motor to generate a haptic feedback output to the visually impaired user based on the corresponding determined vibration intensity.

The method may further include (a) deactivating the plurality of distance sensors and the plurality of vibrating motors when no motion is detected for a predefined period; and (b) reactivating the plurality of distance sensors and the plurality of vibrating motors upon detecting resumption of motion by the visually impaired user.

In some implementations, the generating distance data may include calculating a distance to each detected obstacle using ultrasonic pulses emitted by the ultrasonic sensors; and calculating a distance to a hand-positioned obstacle using the infrared sensor. In some instances, the determining the vibration intensity may include applying a predefined function to the distance data, in which the vibration intensity is calculated as a function of the measured distance to the obstacle and a maximum vibration threshold.

In some implementations, each sensor of the plurality of distance sensors may be mapped to a corresponding vibrating motor, such that each vibrating motor provides haptic feedback based on the distance data from the corresponding sensor.

In some implementations, the method may further include identifying an obstacle within a critical distance threshold; and triggering a maximum vibration intensity output when the obstacle is within the critical distance threshold.

As described previously, in some implementations, the method may include performing a calibration procedure to optimize sensitivity of the plurality of distance sensors based on real-world testing; and storing calibration data to improve future distance measurement accuracy.

In some implementations, adjusting the vibration intensity may be based on feedback provided by the visually impaired user, in which the feedback modifies a sensitivity parameter used in determining vibration intensity.

In some embodiments, one sensing element from a plurality of sensing element(s) 104 may be paired with one vibrating element from the plurality of vibrating element(s) 108 and one processor from a plurality of processors may be assigned to carry out the processing for one or more identified pairs of sensing element and vibrating element. An example of such a set up is illustrated in the system 200 in FIG. 2.

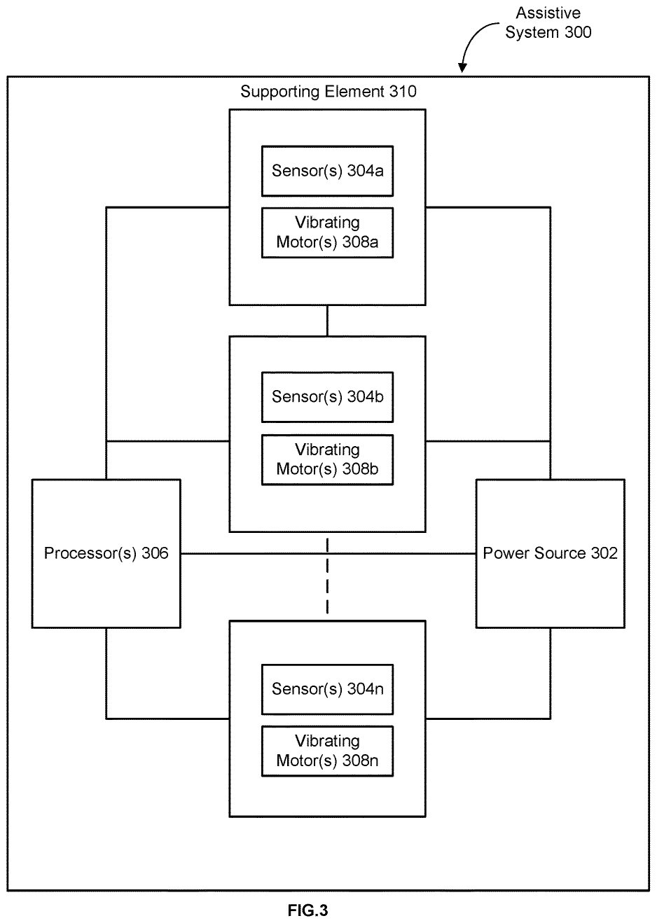

FIG. 3 illustrates a schematic diagram of a system 300, according to an embodiment. The system 300 may be substantially similar in structure and/or function to the system 100 described above with reference to FIG. 1 and/or the system 200 described above with reference to FIGS. 2A and 2B. The system 300 may include sensing element(s) also referred to as “sensor(s)” that are substantially similar in structure and/or function to the sensing element(S) 104 of system 100 described above with reference to FIG. 1. The system 300 may include alerting element(s) also referred to as “vibrating motor(s)” that are substantially similar in structure and/or function to the alerting element(s) 108 of system 100 described above with reference to FIG. 1. The system 300 may include a supporting element 310 substantially similar in structure and/or function to the supporting element 110 of system 100, and a power source 302 substantially similar in structure and/or function to the power source 102 of system 100.

In some embodiments, two or more types of sensors may be strategically grouped to be positioned at a particular portion of the user's body. In some embodiments, one or more sensors or types of sensors may be strategically grouped with a vibratory motor to be positioned at a particular portion of the user's body. For example, in some embodiments, an IR sensor may be paired with an ultrasonic sensor in an identified position on the user's body, the data provided by the IR sensor complementing the data provided by the ultrasonic sensor. The strategic grouping of types of sensors and/or sensors with vibrating motors may be based on considerations like likelihood of user impact with an object (e.g., a user's shoulders may be prone to contact door frames or pillars, user's hands or feet may be prone to contact tables or chairs, and/or the like), user sensitivity to detect vibrations at that position on their body, maneuverability of the portion of the body by the user (e.g., hands and legs are more maneuverable than the torso), and the need for data to generate a full coverage of the user in all 360 degrees of their surrounding environment.

As shown in FIG. 3, the system 300 includes a supporting element 310 that holds ‘n’ grouped sets of sensor(s) and vibrating motors. For example, sensor(s) 304a are grouped with vibrating motor(s) 308a, sensor(s) 304b are grouped with vibrating motor(s) 308, and so on till sensor(s) 304n are grouped with vibrating motor(s) 308n. Each sensor(s)-vibrating motor(s) group is coupled to one or more processor(s) 306 and the power source 302. For example, group of sensor(s) 304a and vibrating motor(s) 308a may be coupled to a processor 306a (not shown in FIG. 3), group of sensor(s) 304b and vibrating motor(s) 308b may be coupled to a processor 306b (not shown in FIG. 3), and so on till the group of sensor(s) 304n and vibrating motor(s) 308n coupled to a processor 306n (not shown in FIG. 3). In some embodiments, such an arrangement may be used to facilitate mapping of sensor(s) and vibrating motor(s) within each group to each other, and the optimal positioning of each group of sensor(s) and vibrating motor(s).

In some embodiments, the grouped sensor-vibrating motor pairs may be suitably and strategically positioned on a user's body to optimally aid in distance perception. The positioning of the sensor(s)-vibrating motor(s) groups, and the grouping by itself (e.g., the number and/or types of sensors and the number and/or types of vibratory motors may be based on any suitable parameters. The positioning may be fine-tuned iteratively over usage and experience of the user. For example, the positioning of the groups of sensor(s) and vibrating motor(s) may be based on parameters like the likelihood of user's impact against an obstacle (e.g., also based on the environment), user's sensitivity to detect vibrations at that portion of the body, maneuverability of the portion of body, the relative demand or use for data that may provide a full 360 degree coverage of the user's immediate environment. In some instances, strategic placement and/or positioning of sensor(s) and/or vibrating motor(s) may also be based on need for redundancy, pair or group sensors to mutually verify data from each other, or to account for errors or loss of data, for example by implementing a weighting scheme for sensors.

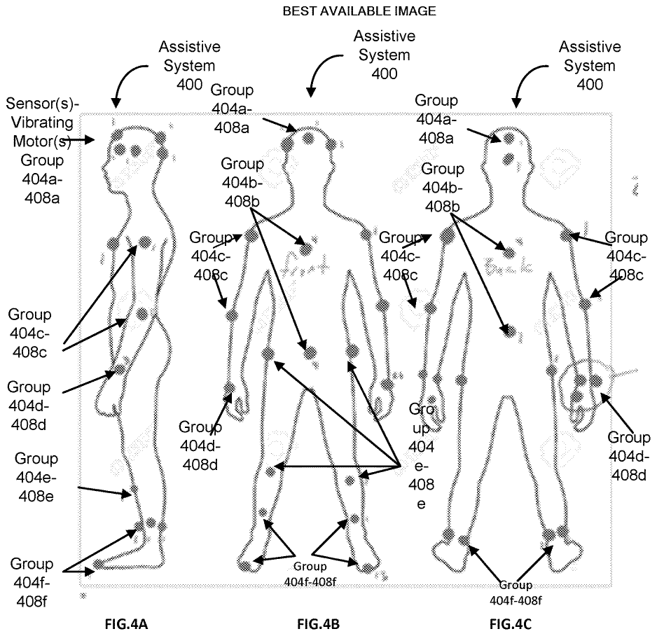

FIGS. 4A-4C illustrate an example pattern of positioning groups of sensors and/or vibrating motors in a system 400, on the body of a user, according to an embodiment. The system 400 may be substantially similar in structure and/or function to the system 100, 200, and/or 300 described herein. FIG. 4A shows a side view of a human user of a system 400, FIG. 4B shows a front view, and FIG. 4C shows the back view of the human user of system 400, according to an embodiment. Each red point indicates the position of a group of sensor(s) and vibrating motor(s) on the user's body. As an example, sensor(s) and vibrating motor(s) in Group 404a-408a may be directed towards placement and position on the user's head. Group 404b-408b may be directed towards placement on the torso of the user's body in the front and back. Group 404c-408c may be directed towards placement on the hands, Group 404d-408d may be directed towards placement on the hands, Group 404e-408e may be directed towards placement along the legs, and Group 404f-408f may be directed towards placement on the feet.

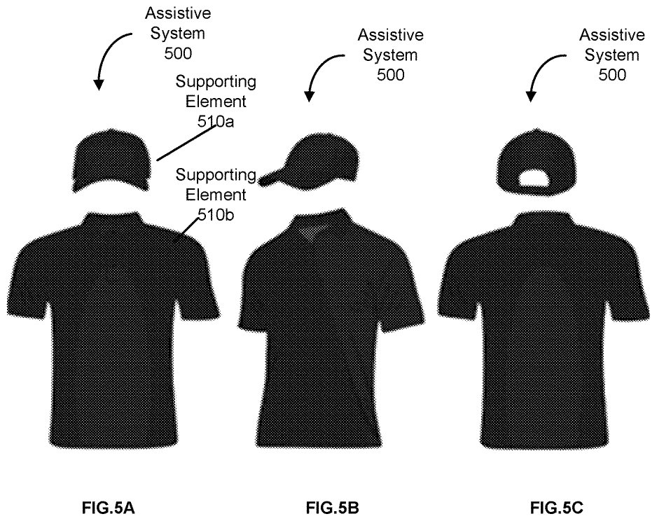

FIGS. 5A, 5B, and 5C are schematic illustrations of exemplary supporting elements used in an assistive system 500, according to and embodiment. function of the distance calculated. The system 500 may be substantially similar in structure and/or function to the system 100, 200, 300, and/or 400 described herein. The system 500 may include a supporting element 510a in the form of a hat and a supporting element 510b in the form of a shirt. The system 500 may include sensing elements in the form of sensor(s) and/or alerting elements in the form of vibrating motor(s) configured to be mounted on the supporting element 510a or the supporting element 510b.

In some instances, the operation of the systems described herein may be described using the following pseudo code:

```
  1. significant change experimentally determined to be delta_x = 3 mm
  2. length of period of time to obtain sensing signal experimentally
  determined as the moving average of 10 measurements taken 10
  milliseconds apart
  3. output power = 0
  delay (10);
//buzzer 1 output logic
  int total1 = 0;
  for(int i = 0;i < 10;i++) // for smoothing, fill total
  total1 = total1 + mySonic1.Distance( );
  int avgNew1 = total1/10;
  if (abs(avgNew1−avgOld1) > 3)
  analogWrite(pinBUZZ1,vibration1); // Output pwm to vibrating element
  else
  analogWrite(pinBUZZ1,0); // Output pwm to vibrating element
  avgOld1 = avgNew1;
```

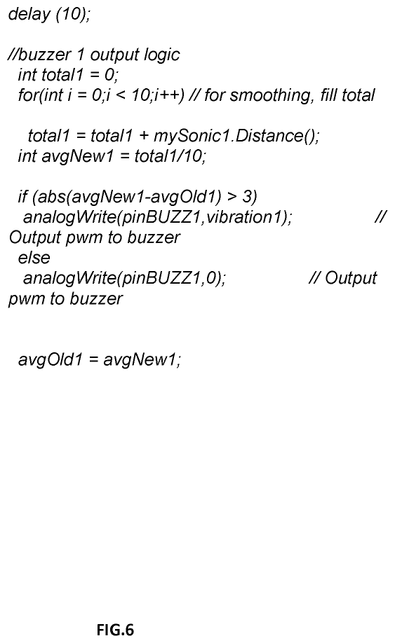

FIG. 6 is an example snippet of code representing instructions provided of an assistive system (e.g., system 100, 200, 300, 400, or 500) described herein, according to an embodiment.

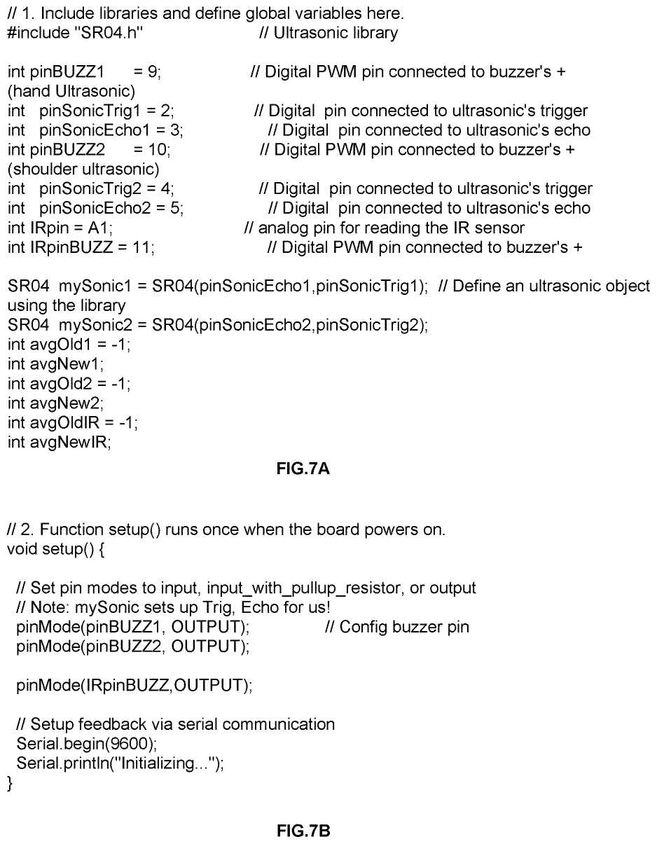

FIGS. 7A and 7B are example snippets of code representing instructions provided of an assistive system (e.g., system 100, 200, 300, 400, or 500) described herein, according to an embodiment.

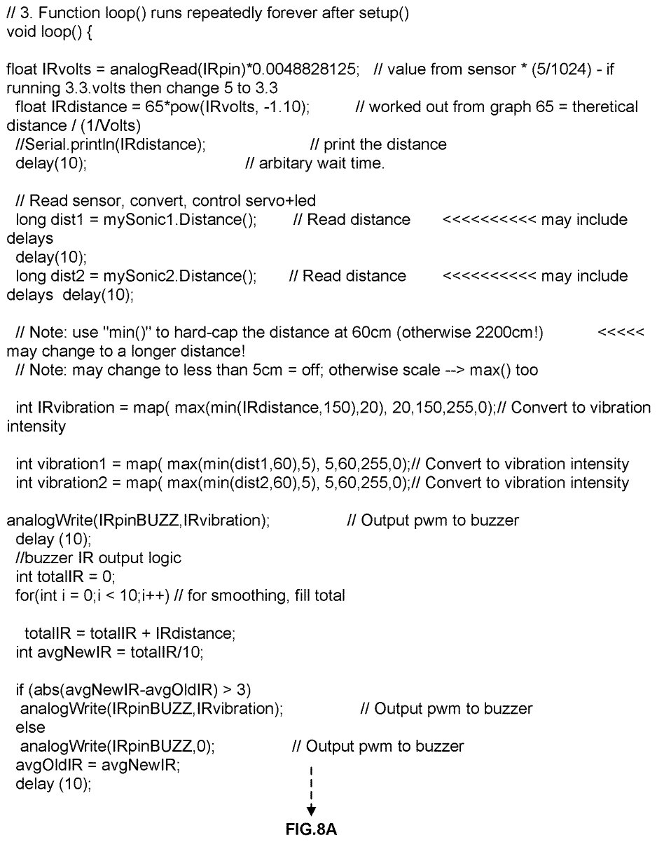

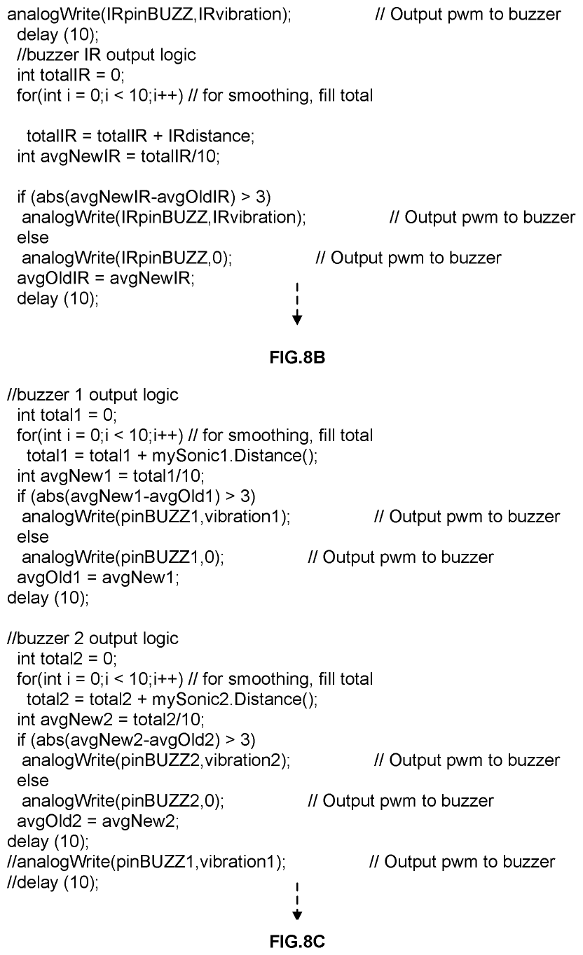

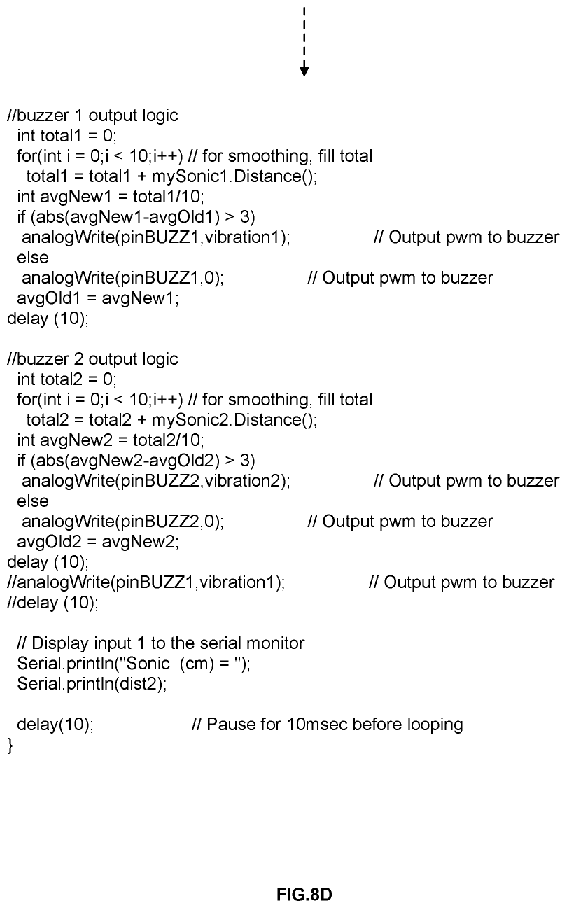

FIGS. 8A-8D are example snippets of code representing instructions provided of an assistive system (e.g., system 100, 200, 300, 400, or 500) described herein, according to an embodiment.

In some embodiments, the methods and systems described herein (e.g., system 100, 200, 300, 400, and/or 500) may include one or more sensors and effectors (e.g., gyroscope, accelerometer) that may be triggered by specific events (e.g., fall, collision, injury, etc.) and may in turn be configured to trigger flags sent to the user and/or to other external devices (e.g., emergency services, medical and/or attendant aid, etc.)

In some embodiments, methods and systems described herein (e.g., system 100, 200, 300, 400, and/or 500) may be used to implement secure attachment of prosthetic limbs (e.g., sense of touch given by pressure applied to five points or more around the attachment point of the prosthetic), supplemented balance (e.g., provide alternate sensory input using gyroscope to supplement inhibited sense of balance), input to supplement or replace loss of proprioception. The disclosed methods and systems may be implemented to provide navigation support, to provide safety for animals or children, provide additional inputs for users of Virtual Reality headsets (e.g., to prevent VR users from inadvertent impact from the surrounding environment), supplemented input for night vision or vision in low light level environments, additional guidance in users of bike helmets, E-bike helmets, motorcycle helmets to serve as a warning system.

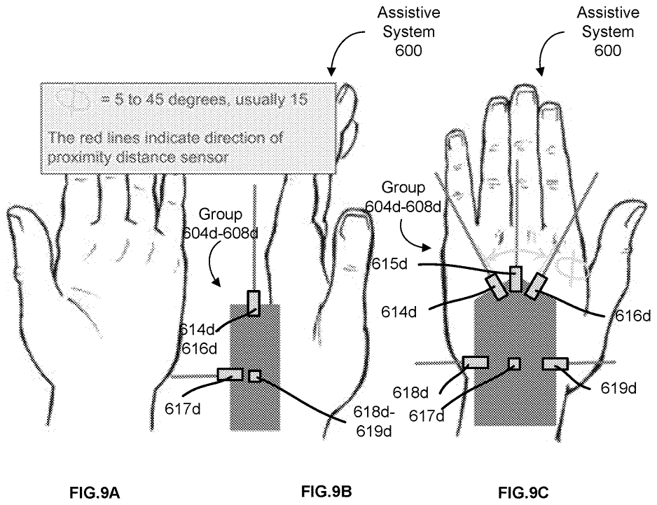

In some embodiments, the sensing/alerting elements included in an assistive system can be grouped and positioned/arranged in any suitable manner to provide desired coverage of a user's environment when wearing the assistive system. In some embodiments, the assistive system may remain valid and functional even when one or more sensing/alerting elements are not included in the arrangement. FIGS. 9A, 9B, and 9C, illustrate orthogonal views of a hand of a user wearing an assistive system 600, according to an embodiment. The assistive system 600 may be substantially similar in structure and/or function to the assistive systems 100, 200, 300, 400, and/or 500 described herein. The assistive system 600 may include one or more sensing elements, one or more alerting elements, and one or more processors, each operatively coupled to the other to assist a user in vision, object detection, localization, navigation, movement, and/or the like. The one or more sensing elements included in the assistive system 600 may be substantially similar in structure and/or function to the sensing elements described herein with reference to assistive system 100, 200, 300, 400, and/or 500, for example, sensing elements 104, 204a, 304a-n, and/or 404a-f. The one or more alerting elements included in the assistive system 600 may be substantially similar in structure and/or function to the alerting elements described herein with reference to assistive system 100, 200, 300, 400, and/or 500, for example, sensing elements 108, 208a, 308a-n, and/or 408a-f.

In some embodiments, the sensing/alerting elements in the assistive system 600 may be grouped as described herein. As shown in FIGS. 9A, 9B, and 9C, the assistive system 600 may include sensing/alerting elements grouped as part of group 604d-608d. FIGS. 9A, 9B, and 9C show illustrations depicting orthogonal views of a user's hand, while wearing the assistive system 600. FIG. 9A shows the user's hand palm up, FIG. 9B in side view, and FIG. 9C with palm facing down. The sensing/alerting element group 604d-608d is shown with individual sensing/alerting elements positioned following a specific arrangement and/or orientation. The sensing/alerting elements may include 614d, 615d, 616d, 617d, 618d, and 619d. Each sensing/alerting element may be positioned and/or arranged in a specified manner at various locations on the user's hand to provide a suitable directional coverage of the surrounding environment of the user.

For example, according to some embodiments, as shown in FIGS. 9B and 9C, the sensing/alerting elements 614d, 615d, and 616d may be positioned in a forward location on a user's hand relative to the user's wrist/forearm, with the three sensing/alerting elements 614d, 615d, and 616d oriented in three different angles pointing outward from the wrist each sensing/alerting element at an angular separation of φ degrees from the adjacent sensing/alerting element, as shown by the lines. In some implementations, the angular separation φ may be any angle from about 0° to about 120° with any angle therebetween. In some implementations, the angular separation may be less than 1° (e.g., no angular separation at all). In some implementations, the sensing/alerting elements may serve as redundant input sources sampling the same portions of the environment, one sensing/alerting element serving as a fallback for the other(s) in case of a failure. In some embodiments, the sensing/alerting elements having relatively small or no angular separation between themselves may be configured to provide complementary input data (e.g., by virtue of being sensing/alerting elements of different types, different input ranges, different sensitivities to input, different sensitivities to environmental factors, etc.). In some implementations, the angular separation φ may be any angle from about 1° to about 90°. In some implementations, the angular separation φ may be any angle from about 5° to about 45°. While described and shown in FIGS. 9A, 9B, and 9C as three sensing/alerting elements, in some embodiments, the number of sensing/alerting elements may be any suitable number (e.g., 2, 3, 4, 5, 6, 7, 8, and so on) with any suitable amount of linear separation in placement and any suitable amount of angular separation in orientation. In some implementations, there may be two sensing/alerting elements with an angular separation of any suitable angle from about 0° to about 270°. The assistive system 600 and the group 604d-608d may further include sensing/alerting elements 617d, 618a, and 619d also directionally oriented, for example, the sensing/alerting element 618d pointing leftward, the sensing/alerting element 619d pointing rightward, and sensing/alerting element 617d pointing orthogonally at an angle perpendicular to the surface of the user's hand, as shown by the lines.

In some implementations, for example, the sensing/alerting elements 614d, 615d, 616d, 617d, 618d, and 619d may be directional distance sensors, with each sensor coupled with a motor to provide feedback to the user when that sensor is triggered or activated. In some embodiments, the sensing/alerting elements 614d, 615d, 616d, 617d, 618d, and 619d may be directional distance sensors with a subset of the directional sensors coupled to one or more motors configured to provide feedback upon triggering of the sensor(s) to which the motor(s) are coupled.

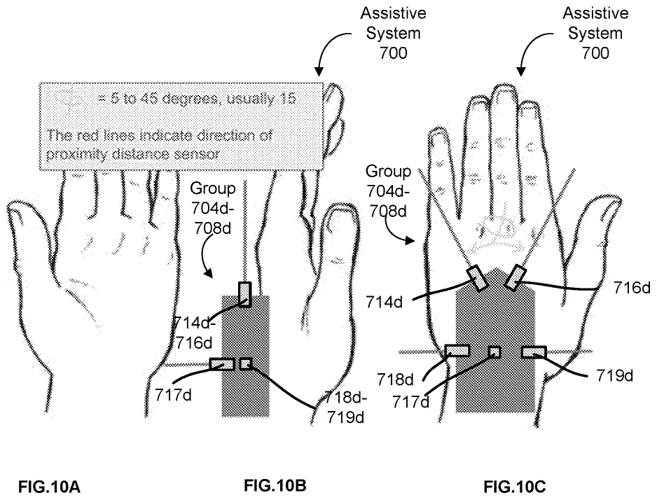

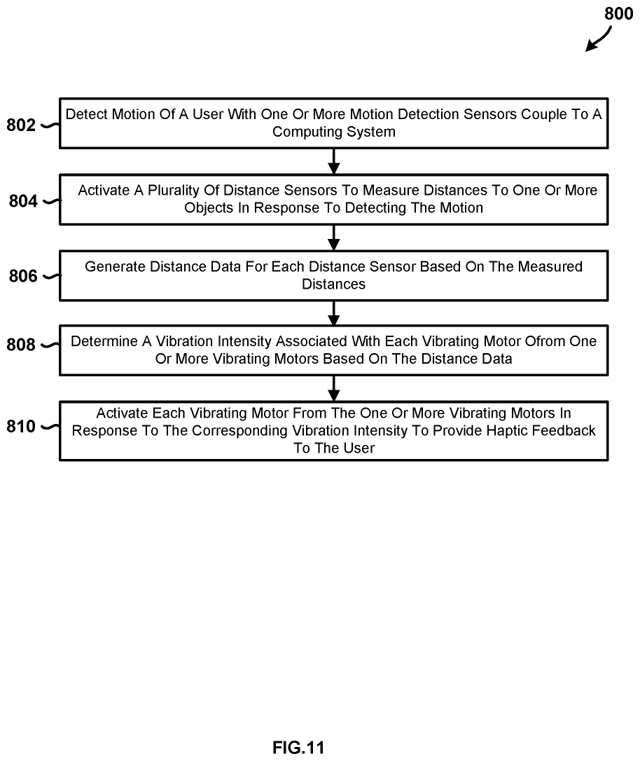

FIGS. 10A, 10B, and 10C illustrate orthogonal views of a hand of a user wearing an assistive system 700, according to an embodiment. The assistive system 700 may be substantially similar in structure and/or function to the assistive systems 100, 200, 300, 400, 500, and/or 600 described herein. The assistive system 700 may include one or more sensing elements, one or more alerting elements, and one or more processors, each operatively coupled to the other to assist a user in vision, object detection, localization, navigation, movement, and/or the like. The one or more sensing elements included in the assistive system 700 may be substantially similar in structure and/or function to the sensing elements described herein with reference to assistive system 100, 200, 300, 400, 500, and/or 600, for example, sensing elements 104, 204a, 304a-n, 404a-f, and/or 604d. The one or more alerting elements included in the assistive system 700 may be substantially similar in structure and/or function to the alerting elements described herein with reference to assistive system 100, 200, 300, 400, and/or 500, for example, sensing elements 108, 208a, 308a-n, 408a-f, and/or 608d.

In some embodiments, the sensing/alerting elements in the assistive system 700 may be grouped as described herein. In some embodiments, the assistive system 700 may remain valid and functional even when one or more sensing/alerting elements are not included in the arrangement. As shown in FIGS. 10A, 10B, and 10C, the assistive system 700 may include sensing/alerting elements grouped as part of group 704d-708d. Similar to FIGS. 9A, 9B, and 9C described above, FIGS. 10A, 10B, and 10C show illustrations depicting orthogonal views of a user's hand, while wearing the assistive system 700. FIG. 10A shows the user's hand palm up, FIG. 10B shows a side view, and FIG. 10C shows an illustration of the user's hand palm facing down. The sensing/alerting element group 704d-708d is shown with individual sensing/alerting elements positioned following a specific arrangement and/or orientation. The sensing/alerting elements may include 714d, 716d, 717d, 718d, and 719d. Each sensing/alerting element may be positioned and/or arranged in a specified manner at various locations on the user's hand to provide a suitable directional coverage of the surrounding environment of the user.

For example, according to some embodiments, as shown in FIG. 10B and 10C, the sensing/alerting elements 714d and 716d may be positioned in a forward location on a user's hand relative to the user's wrist/forearm, with the sensing/alerting elements 714d and 716d oriented in two different angles pointing outward from the wrist each sensing/alerting element at an angular separation of φ degrees from the adjacent sensing/alerting elements, as shown by the lines. The angular separation φ may be any angle from about 5 degrees to about 45 degrees. In some embodiments, the assistive system 700 and the group 704d-708d may further include sensing/alerting elements 717d, 718a, and 719d also directionally oriented, for example, the sensing/alerting element 718d pointing leftward, the sensing/alerting element 719d pointing rightward, and sensing/alerting element 717d pointing orthogonally at an angle perpendicular to the surface of the user's hand, as shown by the lines. sensor arrangement with a middle sensor pointing forward, while FIG. 10B shows a sensor arrangement without the middle sensor.

In some implementations, for example, the sensing/alerting elements 714d, 716d, 717d, 718d, and 719d may be directional distance sensors, with each sensor coupled with a motor to provide feedback to the user when that sensor is triggered or activated. In some embodiments, the sensing/alerting elements 714d, 716d, 717d, 718d, and 719d may be directional distance sensors with a subset of the directional sensors coupled to one or more motors configured to provide feedback upon triggering of the sensor(s) to which the motor(s) are coupled.

FIG. 11 is a flowchart illustrating a method 800 of using an assistive system for providing navigation assistance to a user, according to an implementation. The method 800 may be implemented using any of the assistive systems described herein, including systems 100, 200, 300, 400, 500, 600, and/or 700. The assistive system can include a computing system having one or more processors (e.g., processor(s) 106, 306), one or more memories, one or more motion detection sensors, a plurality of distance sensors (e.g., sensing elements 104, 204a, 304a-n, 404a-f, 604d, 704d), and a plurality of vibrating motors (e.g., alerting elements 108, 208a, 308a-n, 408a-f, 608d, 708d).

At block 802, the method 800 includes detecting motion of a user with one or more motion detection sensors coupled to a computing system. In some embodiments, the motion detection sensor may include an accelerometer, gyroscope, or other suitable sensor configured to detect user movement. For example, the motion detection sensor may transmit signals indicating user movement above a predefined threshold, such as when the user begins walking or moving their hand. The detection of motion may be used to trigger activation of other components in the assistive system, thereby conserving power when the user is stationary.

At block 804, the method 800 includes activating a plurality of distance sensors (also referred to as sensing elements) to measure distances to one or more objects in response to detecting the motion. In some embodiments, the plurality of distance sensors may include ultrasonic sensors, infrared (IR) sensors, laser sensors, and/or proximity sensors, such as sensing elements 104, 204a, 304a-n, and/or 404a-f described herein. For example, upon detecting motion of the user, the processor(s) 106 may send an activation signal to the sensing elements 104 to begin emitting ultrasonic pulses or infrared signals to measure distances to obstacles in the environment surrounding the user.

At block 806, the method 800 includes generating distance data for each distance sensor based on the measured distances. In some embodiments, generating distance data may include calculating a distance to each detected obstacle using ultrasonic pulses emitted and received by the ultrasonic sensors, and/or calculating a distance to an obstacle using the infrared sensor. The processor(s) 106 may perform one or more processing blocks on the data received by the sensing elements 104, including averaging, smoothing, filtering, measuring changes over time, and/or comparing to predetermined threshold values.

At block 808, the method 800 includes determining a vibration intensity associated with each vibrating motor (also referred to as alerting element) from one or more vibrating motors based on the distance data. In some embodiments, determining the vibration intensity may include applying a predefined function to the distance data, such that the vibration intensity is calculated as a function of the measured distance to the obstacle and a maximum vibration threshold. For example, the processor(s) 106 may dynamically adjust a vibration parameter (e.g., intensity, amplitude, frequency, waveform shape, duty cycle, and/or other signature features of the waveform associated with the vibration) of the alerting elements 108 as a function of the distance calculated, such that the vibration intensity increases as the measured distance decreases.

At block 810, the method 800 includes activating each vibrating motor from the one or more vibrating motors in response to the corresponding vibration intensity to provide haptic feedback to the user. In some embodiments, each sensor of the plurality of distance sensors may be mapped to a corresponding vibrating motor, such that each vibrating motor provides haptic feedback based on the distance data from the corresponding sensor. For example, the processor(s) 106 may send control signals to the alerting elements 108 (e.g., vibrating motors 208a, 308a-n, 408a-f) to generate vibrations perceived by the user, the vibrations indicating the approximate direction and distance of detected obstacles in the environment.

In some implementations, each sensing element and/or alerting element can be configured to be easily adjusted to have a suitable range and intensity of detection and/or alerting that is specifically suited to that user.

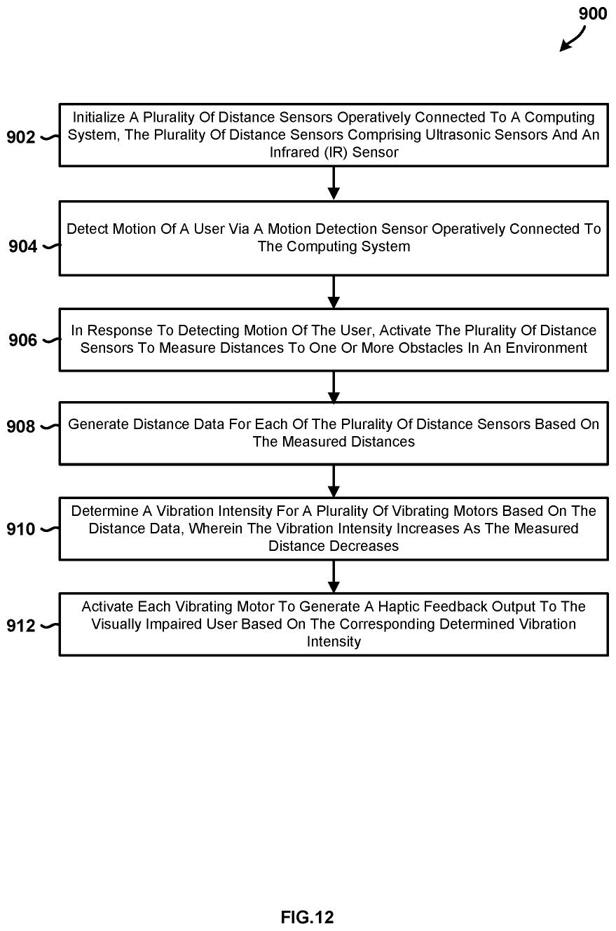

FIG. 12 is a flow diagram illustrating a method 900 of using an assistive system as described herein for providing haptic feedback for navigation assistance to a visually impaired user, according to an implementation. The method 900 can be substantially similar to method 800 in one or more operations. The method 900 may be implemented using any of the assistive systems described herein, including systems 100, 200, 300, 400, 500, 600, and/or 700. The assistive system may include a computing system having one or more processors (e.g., processor(s) 106, 306), one or more memories, one or more motion detection sensors, a plurality of distance sensors (e.g., sensing elements 104, 204a, 304a-n, 404a-f, 604d, 704d), and a plurality of vibrating motors (e.g., alerting elements 108, 208a, 308a-n, 408a-f, 608d, 708d).

At block 902, the method 900 includes initializing a plurality of distance sensors operatively connected to a computing system, the plurality of distance sensors comprising ultrasonic sensors and an infrared (IR) sensor. In some embodiments, initializing the distance sensors may include powering on the sensors, configuring sensor parameters, and establishing communication links between the sensors and the processor(s) 106. For example, the ultrasonic sensors may be configured to emit ultrasonic pulses at a frequency of approximately 40 KHz, and the IR sensor may be configured to sense distances within a range of approximately 20 cm to approximately 150 cm.

At block 904, the method 900 includes detecting motion of a user via a motion detection sensor operatively connected to the computing system. In some embodiments, the motion detection sensor may include an accelerometer, gyroscope, or other suitable sensor configured to detect user movement. For example, the motion detection sensor may transmit signals indicating user movement above a predefined threshold, such as when the visually impaired user begins walking or moving their hand. The detection of motion may be used to trigger activation of the distance sensors, thereby conserving power when the user is stationary.

At block 906, the method 900 includes, in response to detecting motion of the user, activating the plurality of distance sensors to measure distances to one or more obstacles in an environment. In some embodiments, the processor(s) 106 may send an activation signal to the sensing elements 104 to begin emitting ultrasonic pulses or infrared signals. For example, the ultrasonic sensors may emit pulses and receive bounced back signals to measure distances to obstacles in the environment surrounding the user, while the IR sensor may measure distances to hand-positioned obstacles.

At block 908, the method 900 includes generating distance data for each of the plurality of distance sensors based on the measured distances. In some embodiments, generating distance data may include calculating a distance to each detected obstacle using ultrasonic pulses emitted and received by the ultrasonic sensors, and calculating a distance to a hand-positioned obstacle using the infrared sensor. The processor(s) 106 may perform one or more processing blocks on the data received by the sensing elements 104, including averaging, smoothing, filtering, measuring changes over time, and/or comparing to predetermined threshold values.

At block 910, the method 900 includes determining a vibration intensity for a plurality of vibrating motors based on the distance data, wherein the vibration intensity increases as the measured distance decreases. In some embodiments, determining the vibration intensity may include applying a predefined function to the distance data, such that the vibration intensity is calculated as a function of the measured distance to the obstacle and a maximum vibration threshold. For example, the processor(s) 106 may dynamically adjust a vibration parameter (e.g., intensity, amplitude, frequency) of the alerting elements 108 as a function of the distance calculated using a linear function, an exponential function, and/or the like.

At step 912, the method 900 includes activating each vibrating motor to generate a haptic feedback output to the visually impaired user based on the corresponding determined vibration intensity. In some embodiments, each sensor of the plurality of distance sensors may be mapped to a corresponding vibrating motor, such that each vibrating motor provides haptic feedback based on the distance data from the corresponding sensor. For example, the processor(s) 106 may send control signals to the alerting elements 108 (e.g., vibrating motors 208a, 308a-n, 408a-f, 608d, 708d) to generate vibrations perceived by the visually impaired user, the vibrations indicating the approximate direction and distance of detected obstacles in the environment.

In some implementations, the assistive device may implement a process of filtering to remove and/or attenuate environmental interference. In some implementations, the assistive system can be configured to perform a sensor filtering logic operation as a smart navigation system to predict the direction in which the data ought to occur next. As an example, an assistive system may use a predictive validation algorithm to enhance data integrity. Rather than relying solely on historical averaging, this method may proactively extrapolate from a set of preceding measurements deemed valid (e.g., meeting a predefined quality threshold or standard) to generate a predicted value for the subsequent measurement interval. This forward-looking estimation may provide a dynamic benchmark against which the validity of new, incoming sensor data may be assessed, thereby allowing for the effective identification and rejection of anomalous readings.

Upon receiving a new raw measurement (e.g., distance or movement measurement) from a sensor, the system may compare this measurement to the afore-mentioned predicted value. Should the deviation between the new measurement and the predicted value fall within a predetermined tolerance threshold (e.g., a deviation of less than 3 cm), the measurement may be classified or deemed as “valid” and accepted for use in subsequent processing and trend calculations. Conversely, if the deviation exceeds this threshold, the measurement may be classified or deemed “invalid” and may be discarded, preventing the introduction of noise or erroneous data into the filtered output. The threshold may be adjustable based on user preference.

In some implementations, the algorithm may be configured to maintain operational continuity during periods of intermittent signal loss or sensor malfunction. In an embodiment where one or more consecutive measurements may be classified as invalid and discarded, the system may be configured to continue to generate a subsequent predicted value by extrapolating from the last known valid measurement. This may increase the likelihood that the filtering process may bridge temporary data gaps, maintaining a stable and continuous output stream until a new valid measurement is successfully acquired.

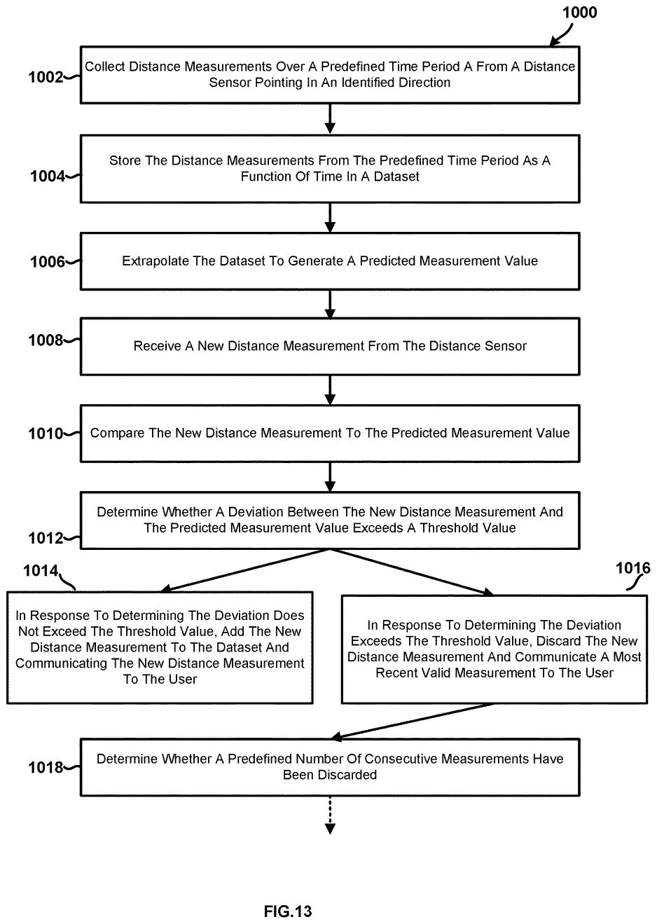

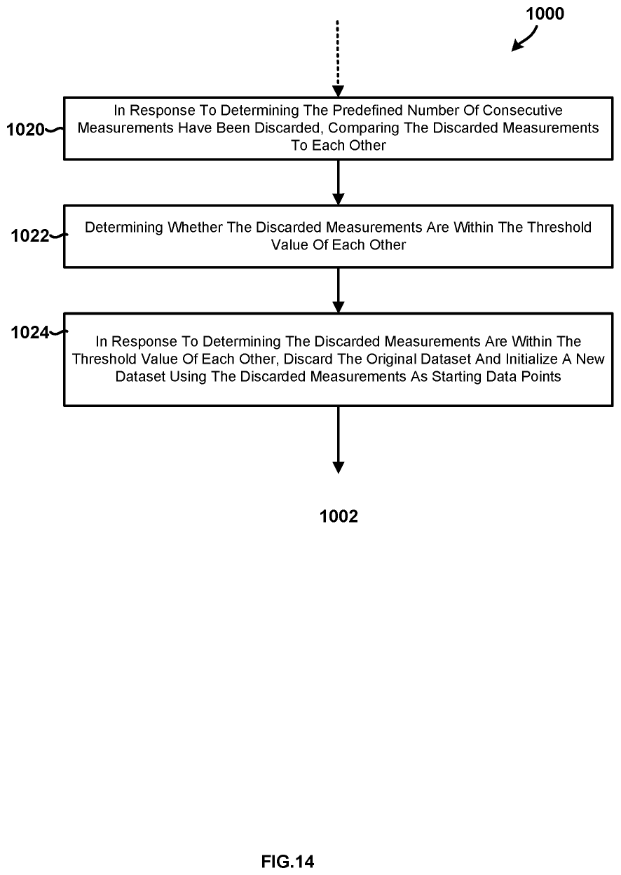

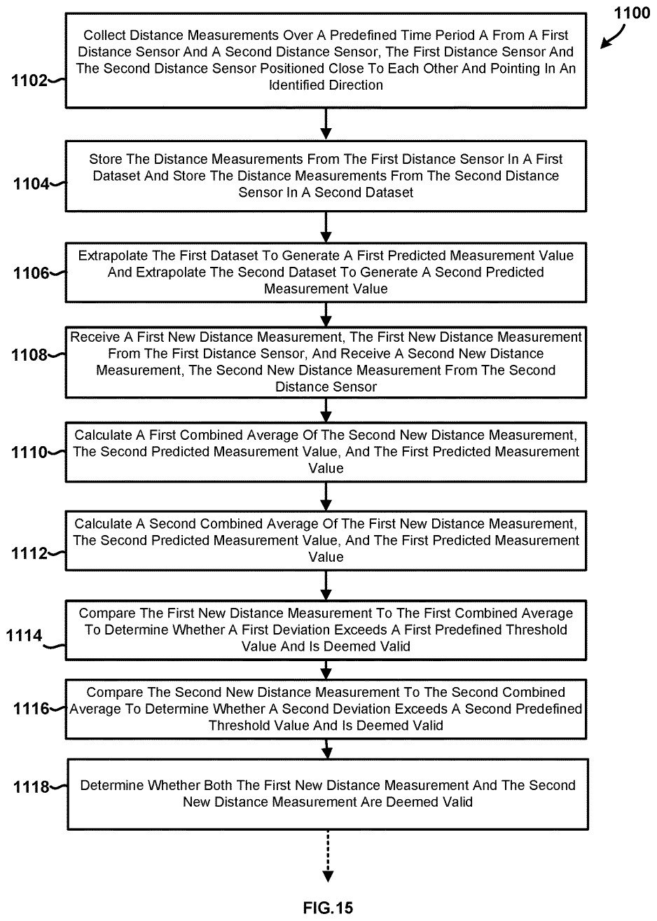

FIGS. 13 and 14 show a flow diagram illustrating a method 1000 for using an assistive system, according to some embodiments. The method 1000 illustrates an exemplary process for filtering environmental interference from distance sensor measurements while using the assistive system, according to an implementation. The method 1000 may be implemented using any of the assistive systems described herein, including systems 100, 200, 300, 400, 500, 600, and/or 700. Blocks 1002-1018 appear in FIG. 13, with a dashed arrow indicating continuation of the method 1000 in FIG. 14. Blocks 1020-1024 appear in FIG. 14, with an arrow from block 1024 returning to block 1002 indicating the operation to continue collecting distance measurements.

At block 1002, the method 1000 includes collecting distance measurements from a distance sensor pointing in a given direction. In some embodiments, the distance sensor may include an ultrasonic sensor, an infrared (IR) sensor, a laser sensor, and/or a proximity sensor, such as sensing elements 104, 204a, 304a-n, and/or 404a-f described herein. For example, the processor(s) 106 may receive distance measurements from a sensing element 104 configured to detect obstacles in a particular direction relative to the user.

At block 1004, the method 1000 includes storing the distance measurements from a predefined time period as a function of time in a dataset. In some embodiments, the predefined time period may be any suitable time interval. For example, in some instances, the predefined time period may be 0.5-5 seconds, or approximately 2-3 seconds, or any suitable range therebetween. For example, the processor(s) 106 may store distance measurements in a memory operatively coupled to the processor(s) 106, the distance measurements being recorded as a function of time to enable subsequent extrapolation.

In some embodiments, at block 1004, the processing system may store distance measurements from a predefined time period as a function of time in a dataset. In some embodiments, the predefined time period may be any suitable time interval. By way of example, the predefined time period may be from about 0.5 seconds to about 5 seconds, from about 2 seconds to about 3 seconds, or another selected interval. By way of further example, processor(s) 106 may store distance measurements in a memory operatively coupled to processor(s) 106, the distance measurements being indexed by time to permit subsequent extrapolation.

At block 1006, the method 1000 includes extrapolating the dataset to generate a predicted measurement value. In some embodiments, the extrapolation may include a linear extrapolation if a simpler implementation is desired. In some embodiments, a polynomial curve may be fit to the dataset of whatever order best fits the dataset, up to a fourth order polynomial. For example, the processor(s) 106 may apply a curve fitting algorithm to the stored distance measurements to predict what an upcoming measurement should be based on the trend of previous measurements.

At block 1008, the method 1000 includes receiving a new distance measurement from the distance sensor. In some embodiments, measurements may be collected at a rate of 10 or 20 or more measurements per second. For example, the processor(s) 106 may receive a new distance measurement from the sensing element 104 at a predefined sampling rate.

At block 1010, the method 1000 includes comparing the new distance measurement to the predicted measurement value. In some embodiments, the processor(s) 106 may calculate a deviation between the new distance measurement and the predicted measurement value generated at block 1006.

At block 1012, the method 1000 includes determining whether a deviation between the new distance measurement and the predicted measurement value exceeds a threshold value. In some embodiments, the threshold value may be approximately 3 cm. This determination may be made because measurements are collected so rapidly that the variation between consecutive measurements should be less than the threshold value under normal operating conditions.

At block 1014, in response to determining the deviation does not exceed the threshold value, the method 1000 includes adding the new distance measurement to the dataset and communicating the new distance measurement to the user. In some embodiments, the processor(s) 106 may update the dataset stored in memory with the new distance measurement and send a control signal to an alerting element 108 to provide haptic feedback based on the new distance measurement.

At block 1016, in response to determining the deviation exceeds the threshold value, the method 1000 includes discarding the new distance measurement as environmental interference and communicating a most recent valid measurement to the user. In some embodiments, the discarded measurement is not included in the dataset going forward. For example, the processor(s) 106 may discard the new distance measurement and instead send a control signal to an alerting element 108 to provide haptic feedback based on the most recent measurement that was not discarded.

At block 1018, the method 1000 includes determining whether a predefined number of consecutive measurements have been discarded. In some embodiments, the predefined number of consecutive measurements may be three. A dashed arrow in FIG. 13 indicates continuation of the method 1000 in FIG. 14.

FIG. 14 is a flowchart illustrating a continuation of the method 1000 for filtering environmental interference from distance sensor measurements, according to an embodiment.

At block 1020, in response to determining the predefined number of consecutive measurements have been discarded, the method 1000 includes comparing the discarded measurements to each other. In some embodiments, the processor(s) 106 may compare the predefined number of discarded measurements (e.g., three consecutive discarded measurements) to determine whether they are consistent with each other.

At block 1022, the method 1000 includes determining whether the discarded measurements are within the threshold value of each other. In some embodiments, the threshold value may be approximately 3 cm. For example, the processor(s) 106 may calculate deviations between each of the discarded measurements to determine whether they fall within the threshold value of each other.

At block 1024, in response to determining the discarded measurements are within the threshold value of each other, the method 1000 includes discarding the original dataset and initializing a new dataset using the discarded measurements as starting data points. In some embodiments, the processor(s) 106 may clear the original dataset from memory and store the previously discarded measurements as the starting data points for a new dataset. An arrow from block 1024 returns to block 1002 to continue collecting distance measurements, and all valid measurements going forward are communicated to the user.

In some implementations, the assistive device may implement a process of filtering to remove and/or attenuate environmental interference, wherein the process of filtering involves dual-sensor configuration employing a dynamically weighted, predictive algorithm to achieve a high degree of accuracy and noise immunity, according to some embodiments. As an example, an assistive system may use a dual-sensor predictive validation algorithm to enhance data integrity. Rather than relying solely on historical averaging, this method may proactively extrapolate from a set of preceding measurements from two (or more) sensors (e.g., distance, movement, etc.) deemed valid (e.g., meeting a predefined quality threshold or standard) to generate a predicted value for the subsequent measurement interval. The dual or multiple sensor prediction method leverages redundant data streams from two independent sensors by calculating a “combined average” for each measurement interval, rather than a simple arithmetic mean. The contribution of each sensor to this combined average is determined by a dynamically adjusted weighting factor, which is calculated based on the historical stability and consistency of each sensor's recent measurements. This adaptive weighting may increase the reliability of data and the likelihood that data from a more reliable and less volatile sensor is given greater credence, thereby reducing the influence of erratic or noisy readings from a single source.

In some implementations, the system may be configured to continuously assesses the performance of each sensor to update its respective weighting factor. For instance, in some embodiments, a sensor exhibiting lower variance in its recent output may be assigned a higher weight, while a sensor with greater variance may be assigned a correspondingly lower weight. This adaptive mechanism may allow the system to intelligently favor the more dependable data source at any given time, enhancing the overall robustness of the measurement process.

Furthermore, the calculated combined average may be subjected to a predictive validation step before its final acceptance. The system may extrapolate from a series of preceding valid data points to generate a predicted value for a current measurement interval. The newly calculated combined average is then compared against this predicted value. If the deviation between the combined average and the predicted value is within a predetermined tolerance threshold, the average may be classified or deemed as “valid” and used for output and subsequent calculations. If the deviation exceeds the threshold, the combined average may be classified or deemed as “invalid” and discarded, effectively preventing anomalous, system-wide data events from corrupting the filtered output stream.

In some implementations, the assistive device may implement a filtering process to remove and/or attenuate environmental interference by using a dual-sensor predictive validation technique. In some embodiments, two sensors mounted close together and directed generally in the same direction may provide two independent measurement streams for the same portion of the environment. The system may extrapolate from preceding valid measurements of each sensor to generate predicted values for a subsequent measurement interval. The system may use those predicted values together with one new measurement from the other sensor to form a combined reference value for validation of each new sensor measurement.

In some implementations, the system may be configured to evaluate each new measurement against a corresponding combined reference value. By way of example, the system may calculate a first combined average from the second new measurement, the second predicted measurement value, and the first predicted measurement value, and may compare the first new measurement to the first combined average. The system may also calculate a second combined average from the first new measurement, the second predicted measurement value, and the first predicted measurement value, and may compare the second new measurement to the second combined average. If deviation between a new measurement and its corresponding combined average falls within a predetermined tolerance threshold, the new measurement may be classified as valid. If the deviation exceeds the threshold, the new measurement may be classified as invalid and may be discarded.

In some implementations, where both new measurements are classified as valid, the system may communicate an average of the two new measurements to the user. Where one new measurement is classified as valid and the other new measurement is classified as invalid, the system may communicate the valid measurement to the user. Where both new measurements are classified as invalid, the system may communicate a most recent valid measurement to the user. This approach may improve robustness by using predictive information from both sensors while reducing the effect of anomalous data from one or both sensors.

Although described above with reference to two sensors, the disclosed predictive validation techniques may be extended to additional sensors that provide complementary measurement streams for a selected direction or region of the environment.

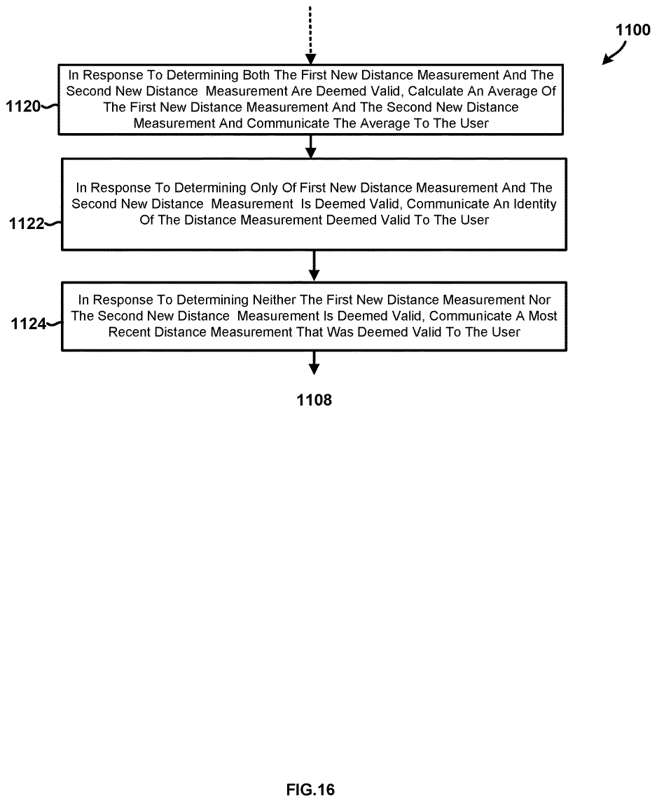

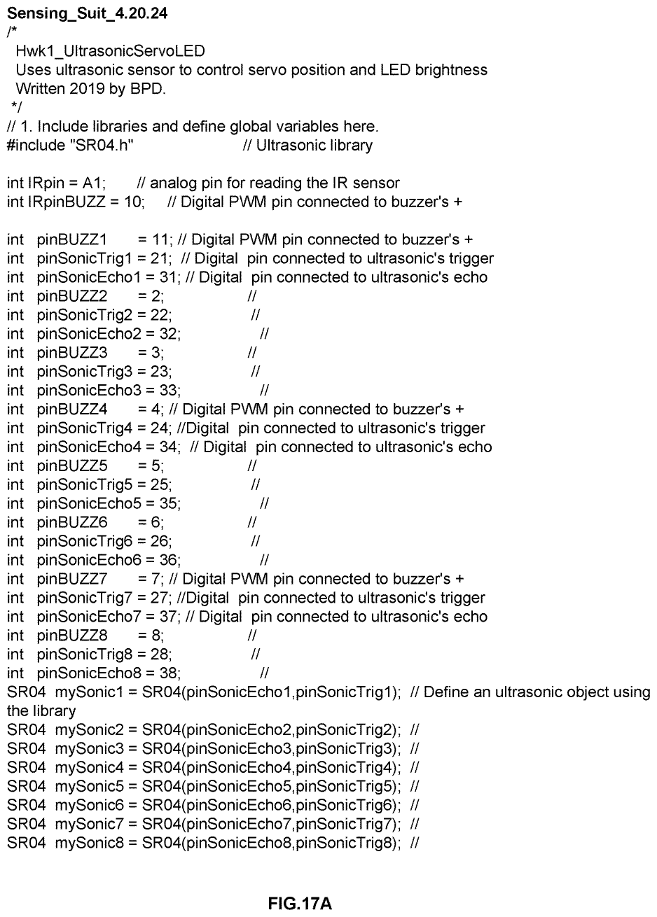

FIGS. 15 and 16 show a flow diagram illustrating a method 1100 for using an assistive system, according to some implementations. Method 1100 may be used while filtering environmental interference in distance measurements where two different distance sensors are mounted close together and point in the same identified direction, according to an embodiment. Blocks 1102-1118 of method 1100 appear in FIG. 15, with a dashed arrow indicating continuation of method 1100 in FIG. 16. Blocks 1120-1124 appear in FIG. 16, with an arrow from block 1124 returning to block 1108 to continue receiving distance measurements. Method 1100 may be implemented using any of the assistive systems described herein, including systems 100, 200, 300, 400, 500, 600, and/or 700. In some embodiments, the two distance sensors may be different types of distance sensors. In some implementations, different types of environmental interference may affect one sensor or sensor type differently from another sensor or sensor type, and method 1100 may use that differential impact to obtain a more accurate representation of the user's environment.

At block 1102, the method 1100 includes collecting distance measurements from a first distance sensor and a second distance sensor mounted close together and pointing in a same direction. In some embodiments, the first distance sensor may include an ultrasonic sensor, and the second distance sensor may include an infrared (IR) sensor, or vice versa. For example, the processor(s) 106 may receive distance measurements from two sensing elements 104 configured to detect obstacles in a same direction relative to the user.

At block 1104, the method 1100 includes storing the distance measurements from the first distance sensor in a first dataset and storing the distance measurements from the second distance sensor in a second dataset. In some embodiments, the processor(s) 106 may store the distance measurements in a memory operatively coupled to the processor(s) 106, with each dataset being recorded as a function of time to enable subsequent extrapolation.

At block 1106, the method 1100 includes extrapolating the first dataset to generate a first predicted measurement value and extrapolating the second dataset to generate a second predicted measurement value. In some embodiments, the extrapolation may include a linear extrapolation or a polynomial curve fit to each dataset. For example, the processor(s) 106 may apply a curve fitting algorithm to each stored dataset to predict what an upcoming measurement should be based on the trend of previous measurements.

At block 1108, the method 1100 includes receiving a first new distance measurement from the first distance sensor and a second new distance measurement from the second distance sensor. In some embodiments, measurements may be collected at a rate of 10 or more measurements per second from each sensor. For example, the processor(s) 106 may receive new distance measurements from both sensing elements 104 at a predefined sampling rate.

At block 1110, the method 1100 includes calculating a first combined average of the second new distance measurement, the second predicted measurement value, and the first predicted measurement value. In some embodiments, the processor(s) 106 may calculate the first combined average to serve as a reference value against which the first new distance measurement is compared.

At block 1112, the method 1100 includes calculating a second combined average of the first new distance measurement, the second predicted measurement value, and the first predicted measurement value. In some embodiments, the processor(s) 106 may calculate the second combined average to serve as a reference value against which the second new distance measurement is compared.

At block 1114, the method 1100 includes comparing the first new distance measurement to the first combined average to determine whether a first deviation exceeds a threshold value. In some embodiments, the threshold value may be approximately 3 cm. For example, the processor(s) 106 may calculate a deviation between the first new distance measurement and the first combined average.

At block 1116, the method 1100 includes comparing the second new distance measurement to the second combined average to determine whether a second deviation exceeds a threshold value. In some embodiments, the processor(s) 106 may calculate a deviation between the second new distance measurement and the second combined average using the same threshold value.

At block 1118, the method 1100 includes determining whether the first new distance measurement is valid and whether the second new distance measurement is valid based on the comparisons at blocks 1114 and 1116. In some embodiments, a measurement is considered valid if its deviation from the corresponding combined average does not exceed the threshold value. A dashed arrow in FIG. 15 indicates continuation of the method 1100 in FIG. 16.

FIG. 16 is a flowchart illustrating a continuation of the method 1100 for filtering environmental interference from distance sensor measurements using dual distance sensors, according to an embodiment.

At block 1120, in response to determining both the first new distance measurement and the second new distance measurement are valid, the method 1100 includes calculating an average of the first new distance measurement and the second new distance measurement and communicating the average to the user. In some embodiments, the processor(s) 106 may send a control signal to an alerting element 108 to provide haptic feedback based on the averaged distance measurement.

At block 1122, in response to determining only one of the first new distance measurement or the second new distance measurement is valid, the method 1100 includes communicating the valid measurement to the user. In some embodiments, the processor(s) 106 may send a control signal to an alerting element 108 to provide haptic feedback based on the single valid distance measurement.

At block 1124, in response to determining both the first new distance measurement and the second new distance measurement are discarded, the method 1100 includes communicating a most recent valid measurement to the user. In some embodiments, the most recent valid measurement may be the same number that was most recently communicated to the user. An arrow from block 1124 returns to block 1108 to continue receiving distance measurements from the first distance sensor and the second distance sensor.

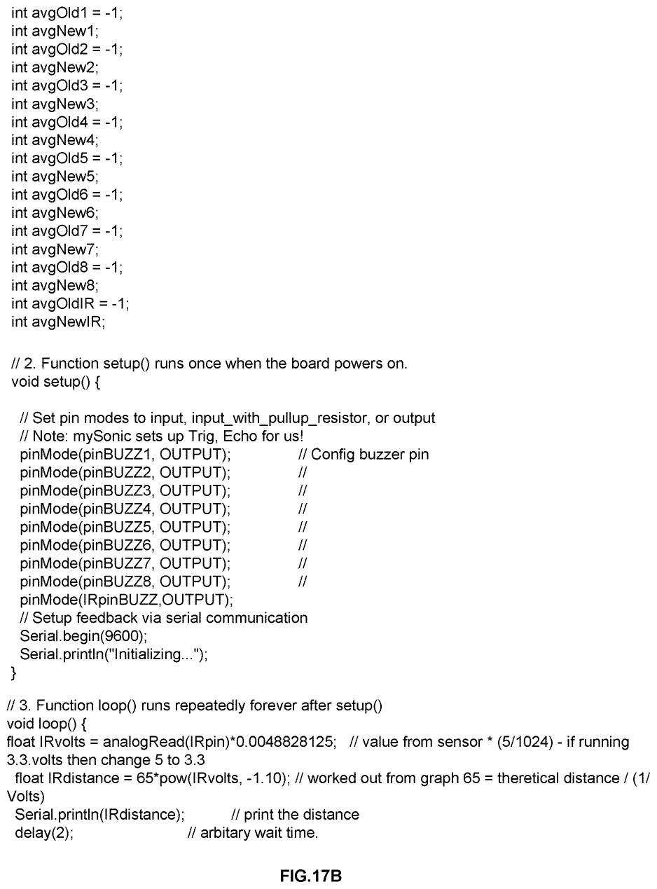

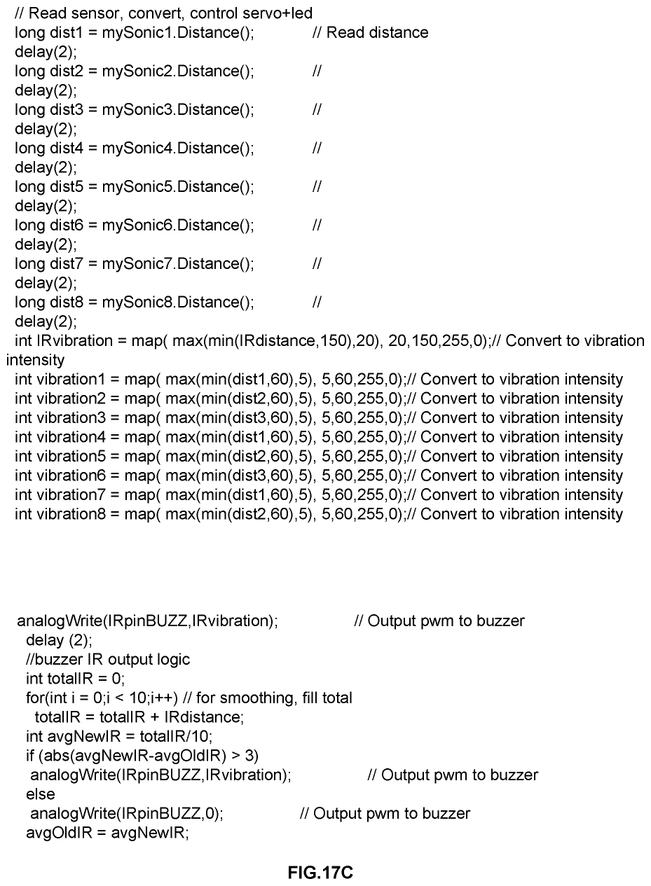

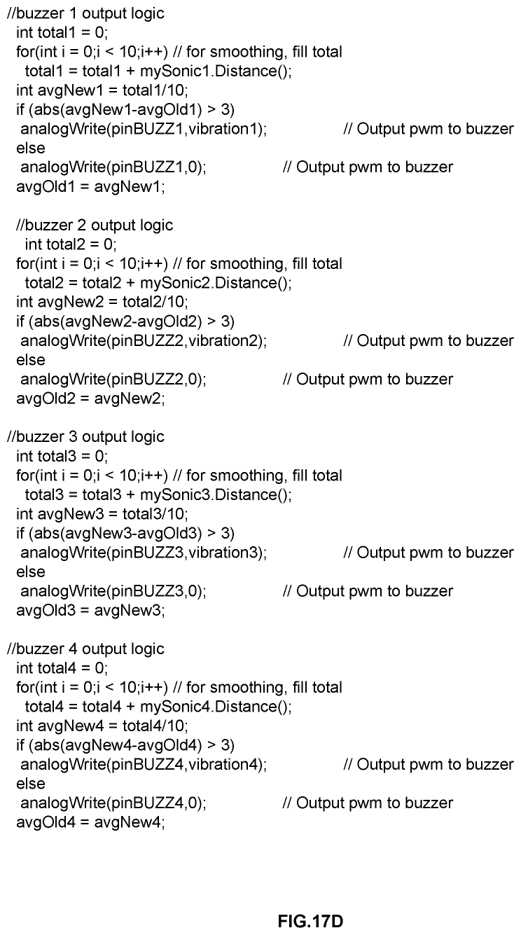

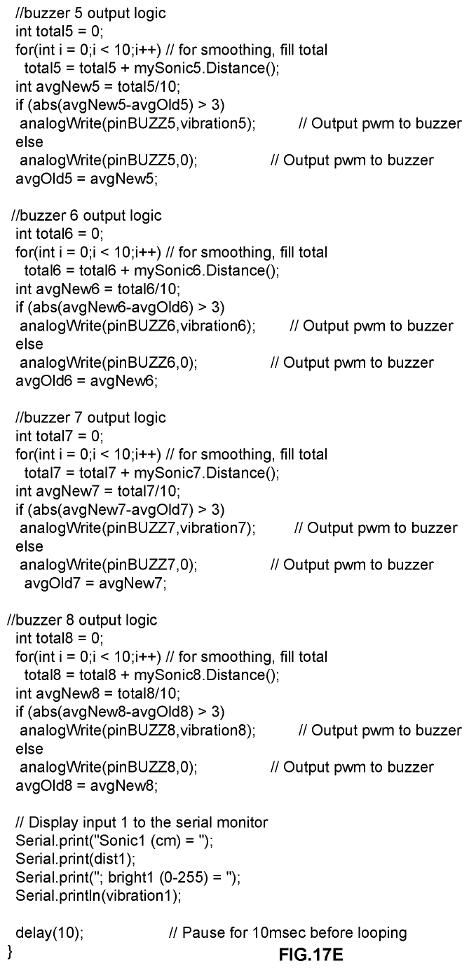

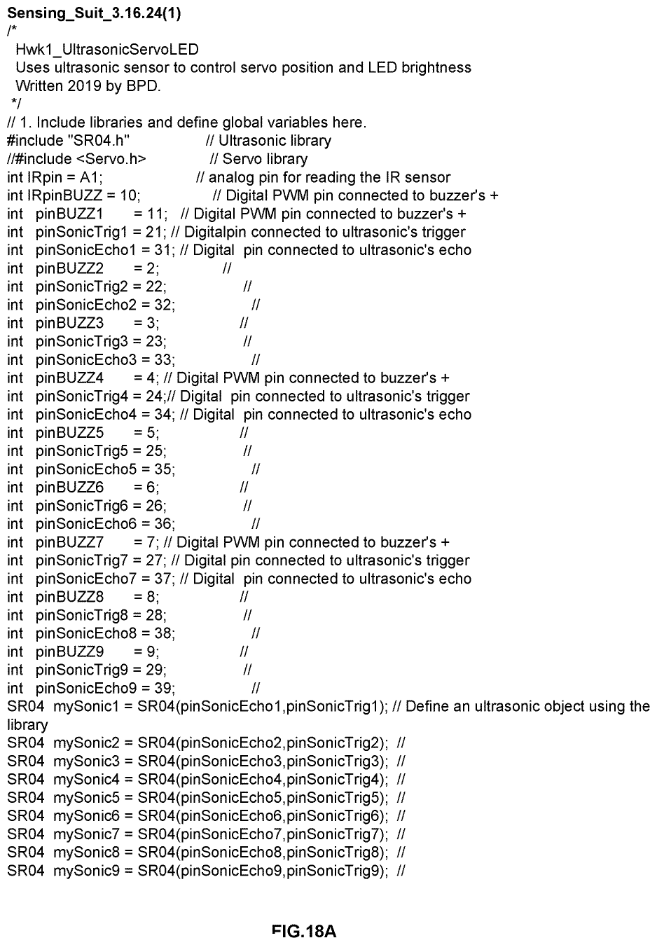

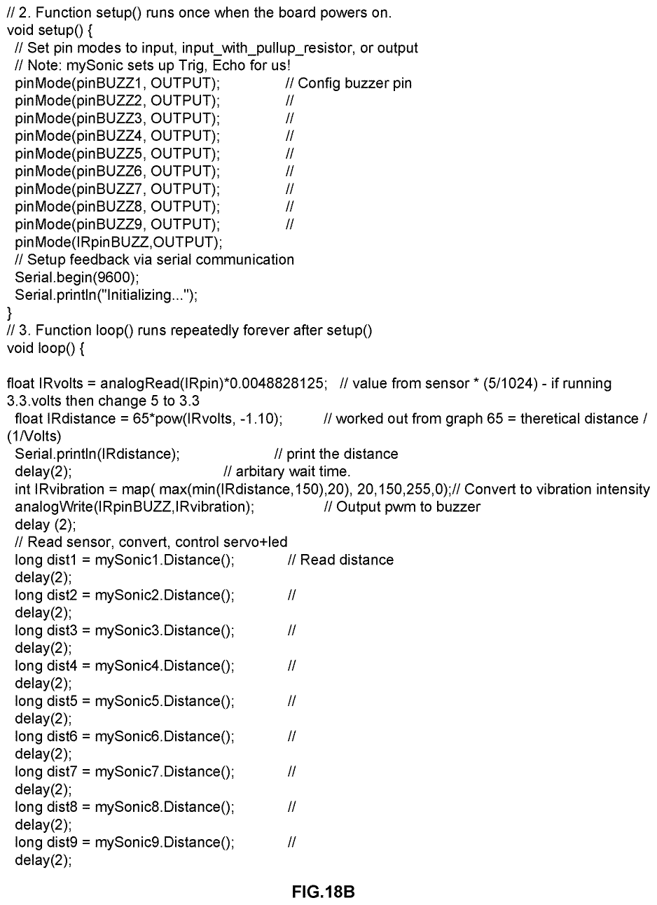

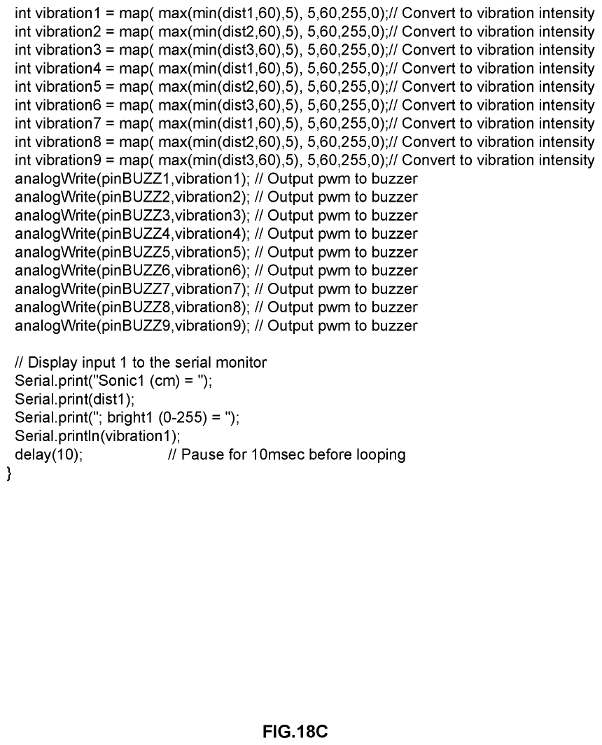

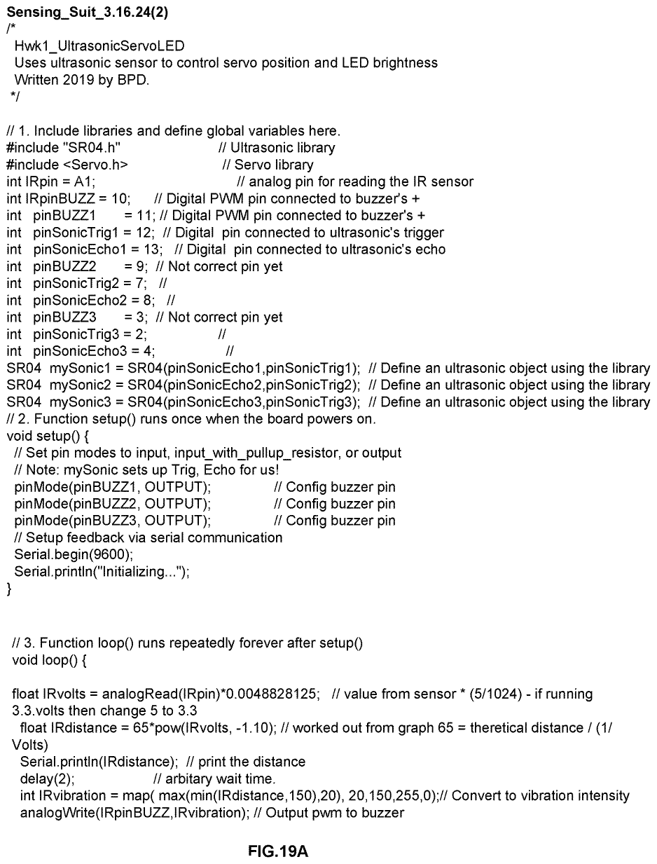

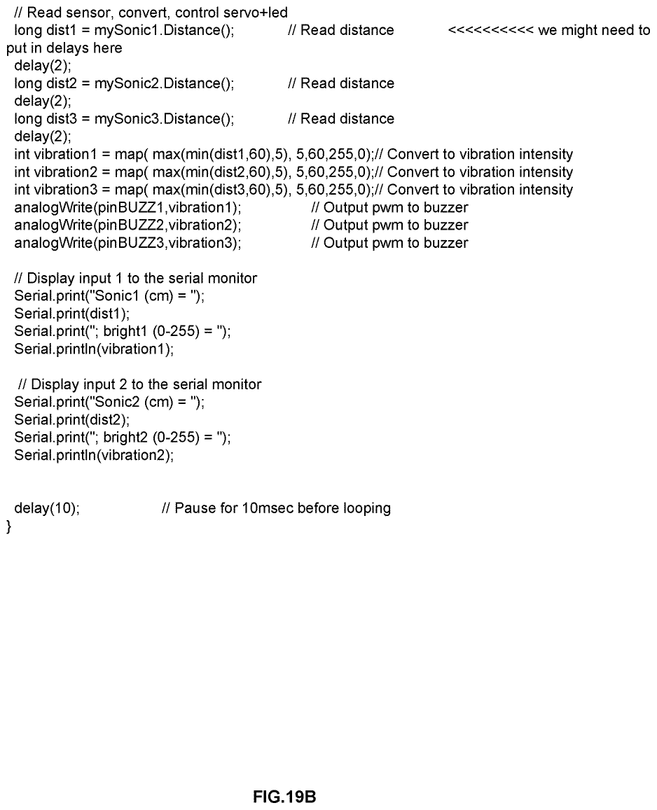

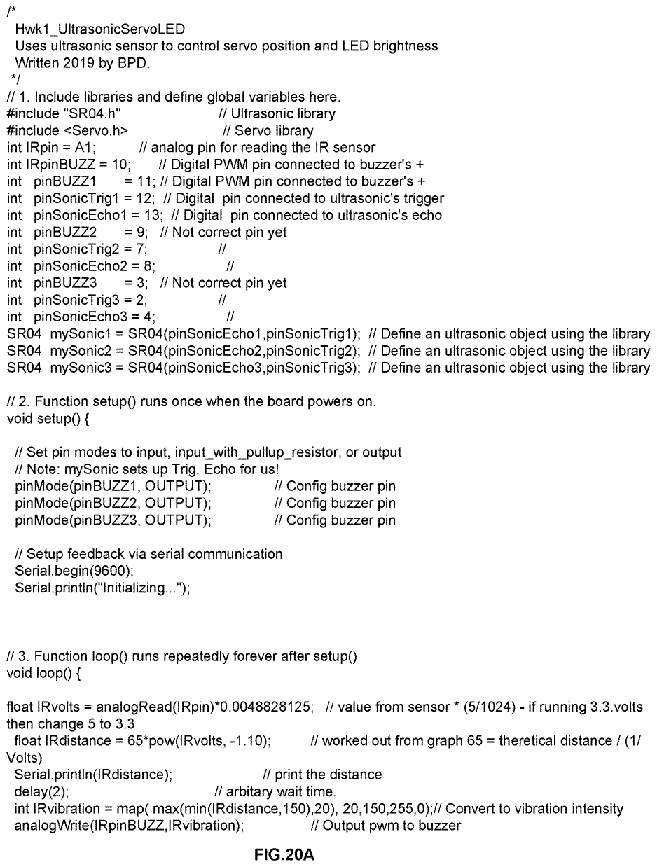

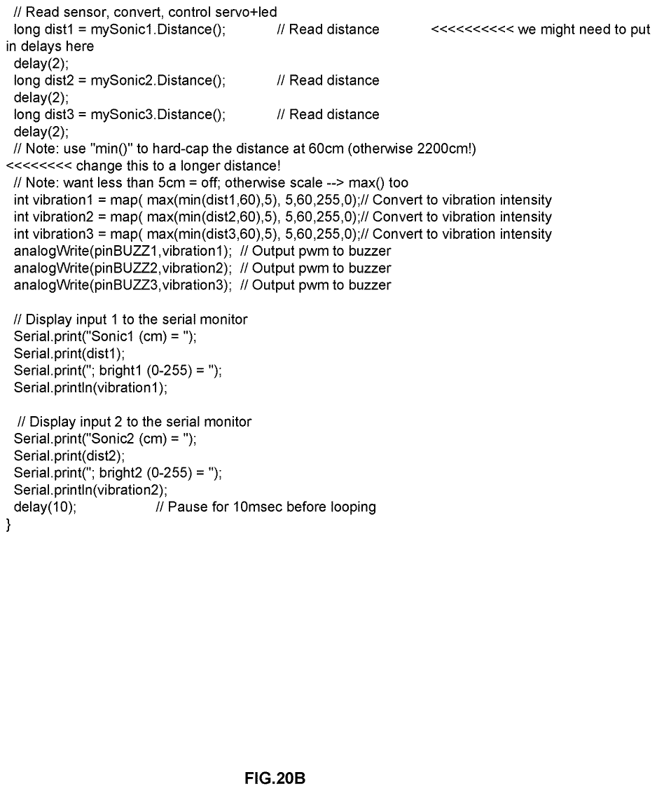

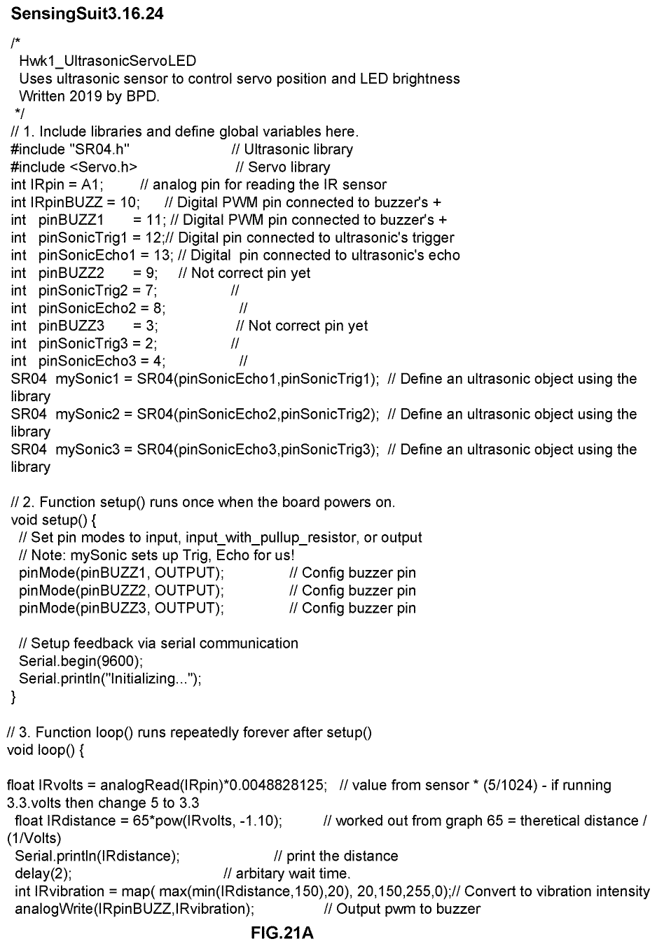

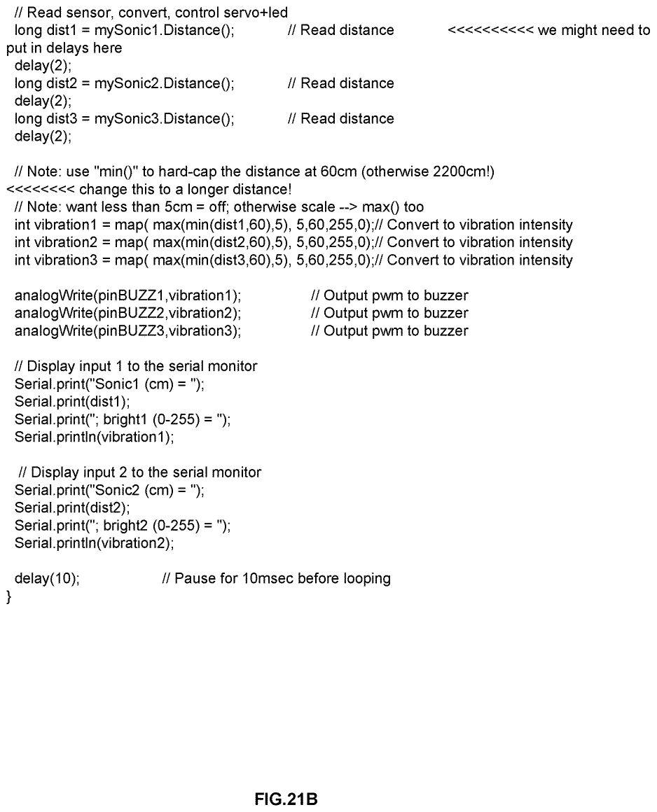

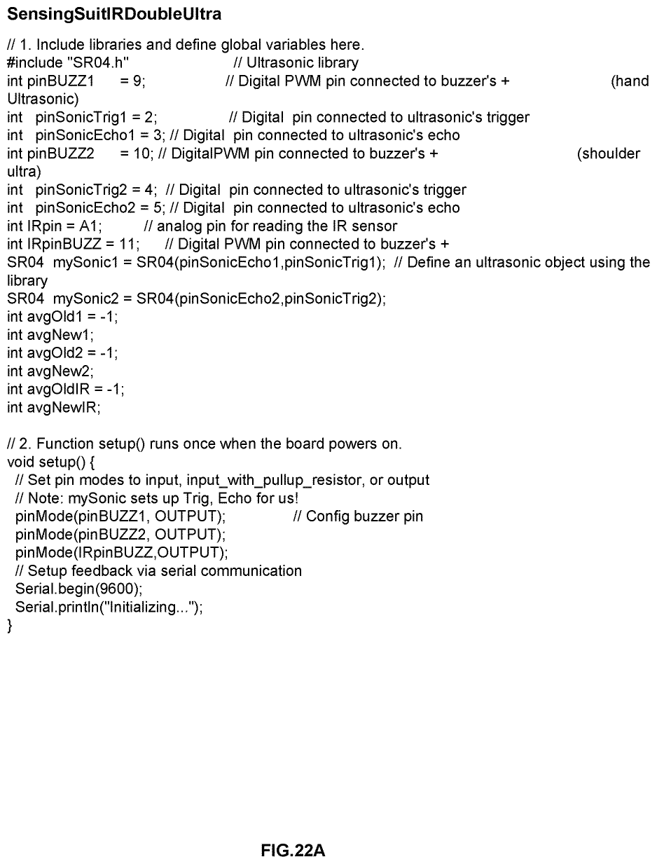

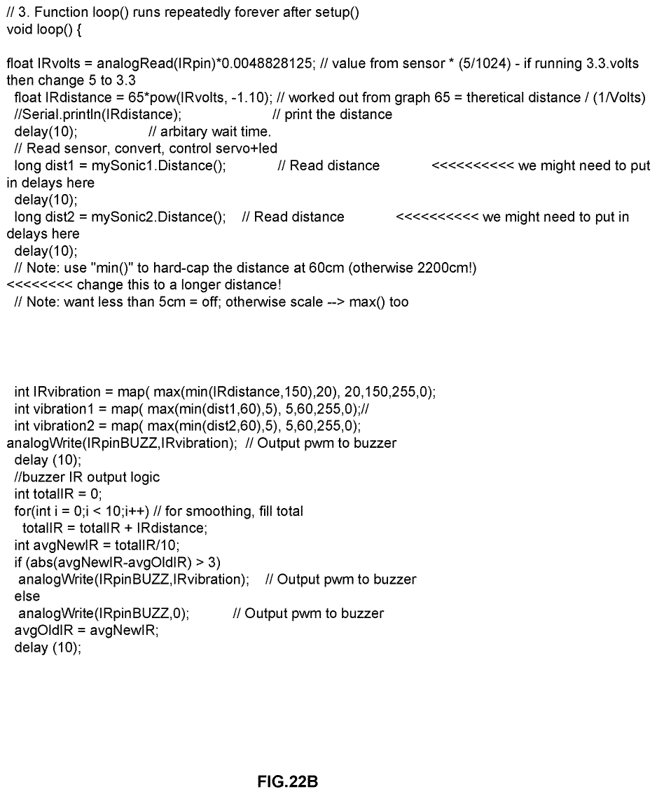

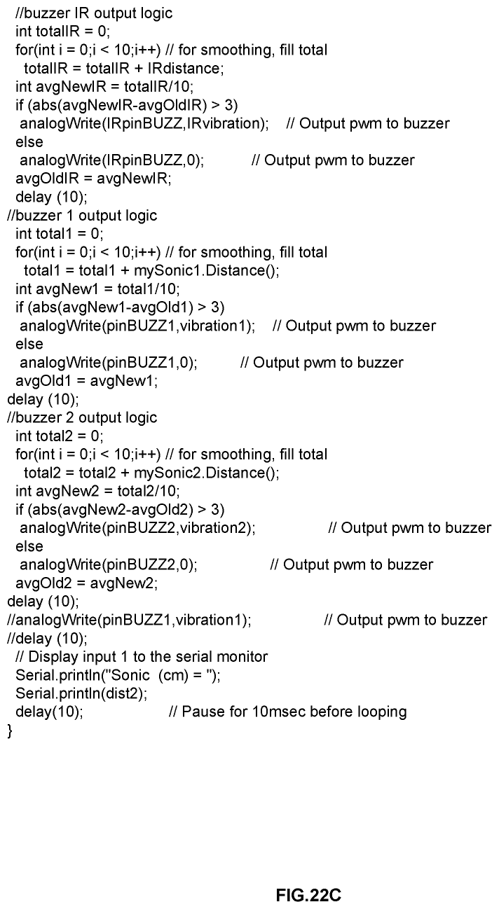

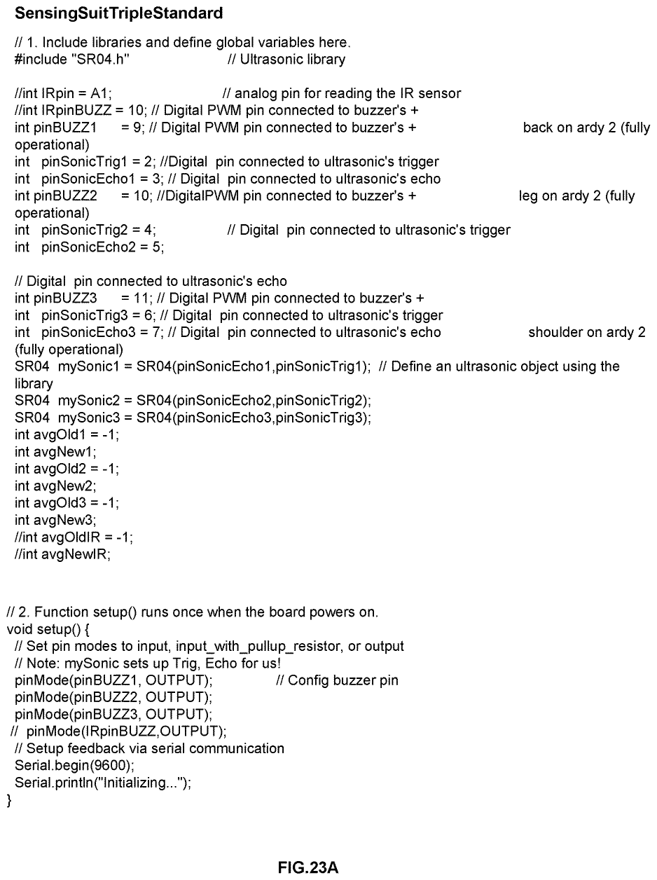

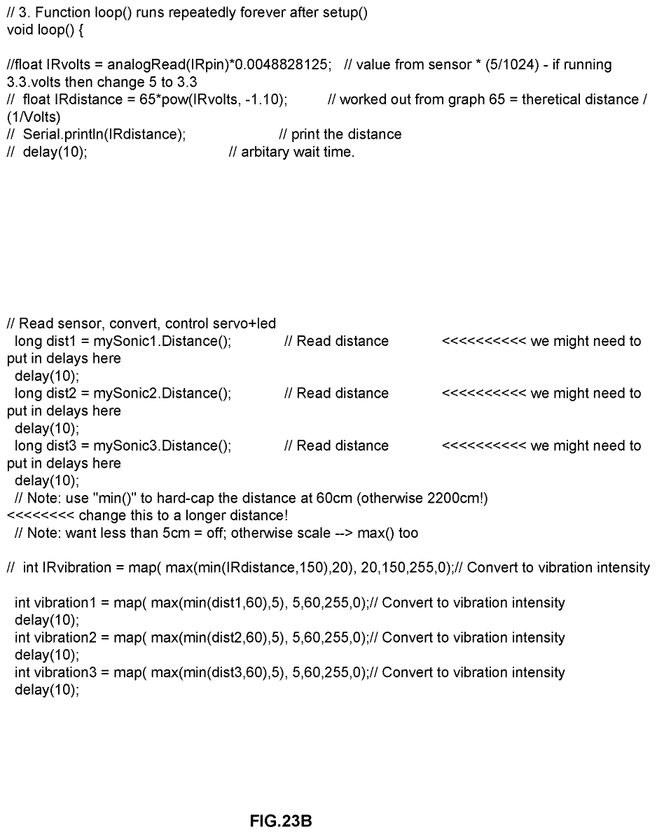

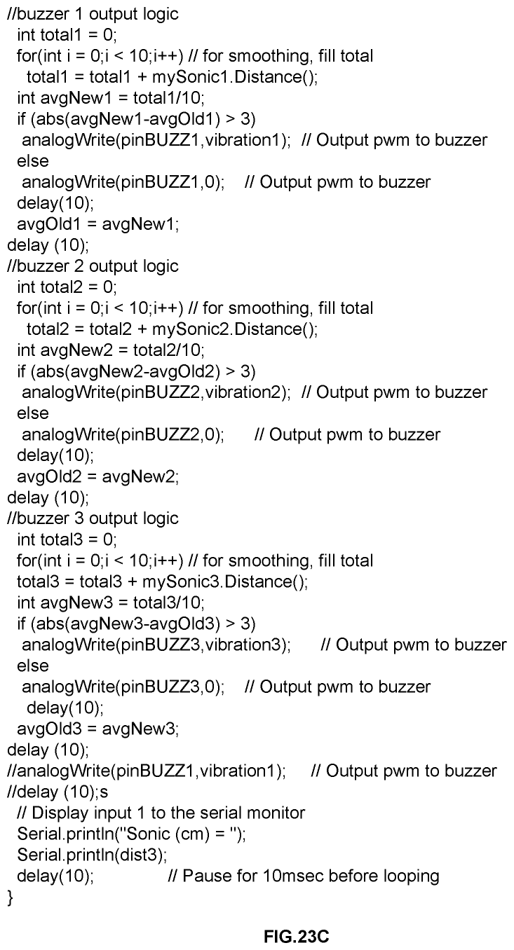

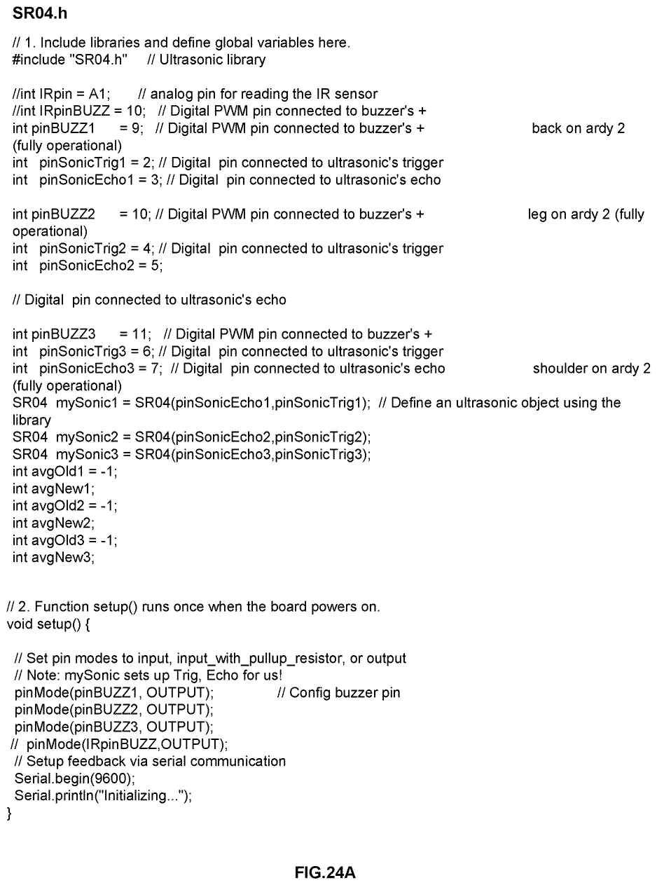

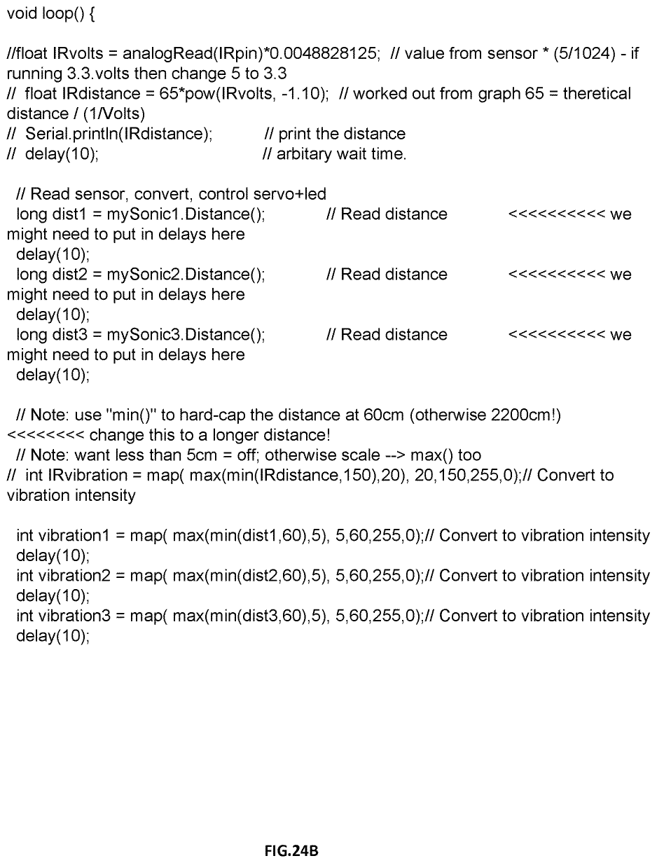

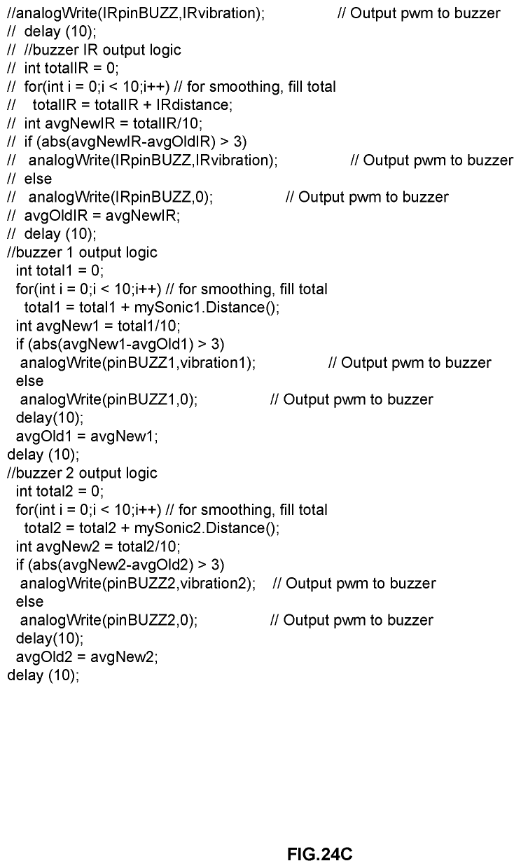

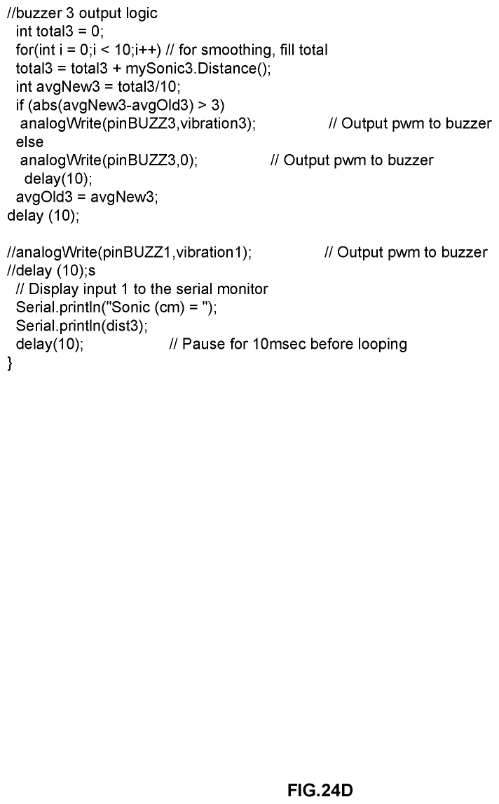

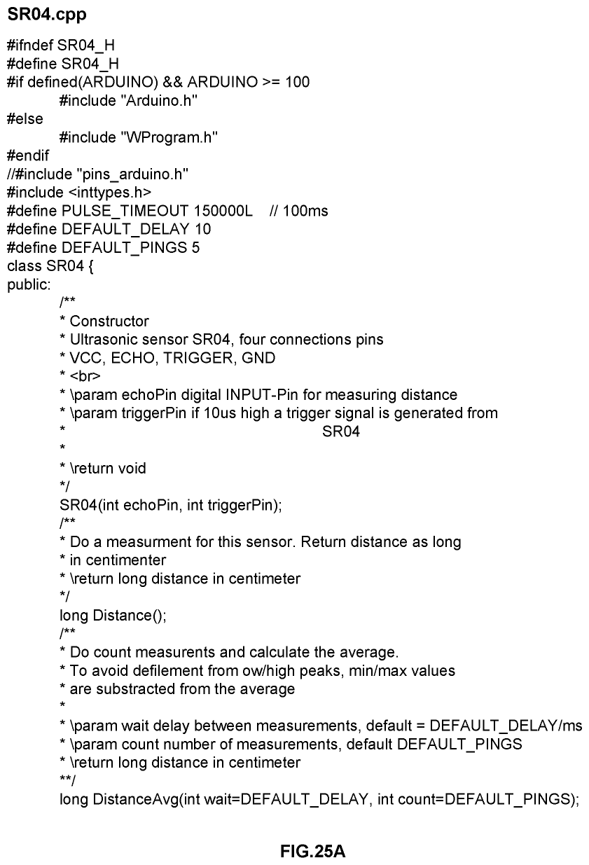

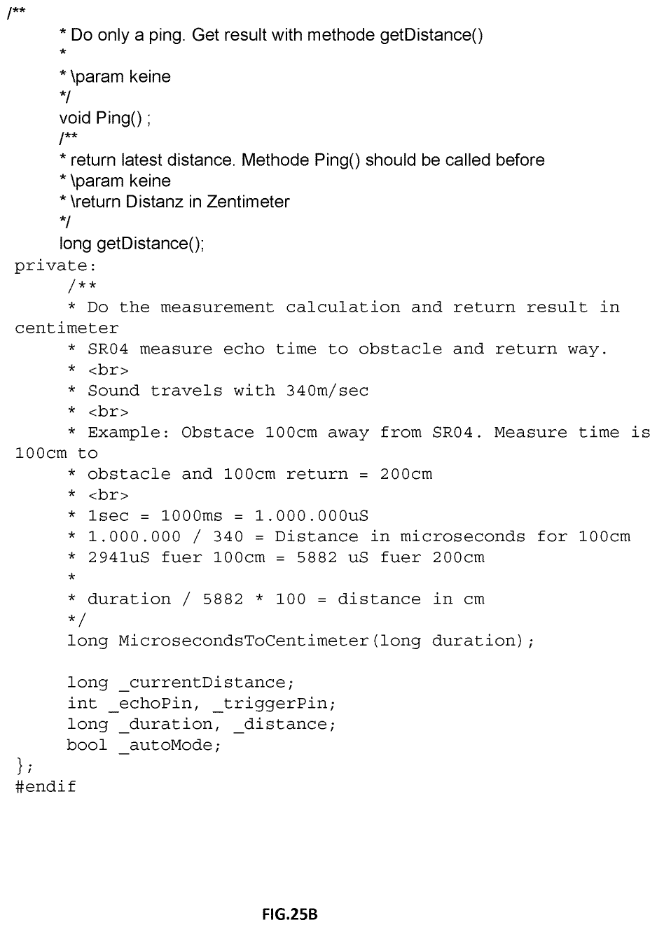

In use, according to one implementation, the systems described herein, including system 100, system 200, system 300, system 400, system 500, system 600, and/or system 700, may include distance sensors or proximity sensors embedded within the supporting element, the sensors including ultrasonic sensors and infrared sensors. The ultrasonic sensors and infrared sensors may face outward from the body and may sense the environment around the user, with positioning selected to improve resolution in detection and location of nearby objects. The system may indicate approximate direction of objects. By way of example, each sensor may be operatively coupled to processor(s) 106, and processor(s) 106 may process signals received by the sensor such that, when a signal reaches a predetermined threshold value that indicates detection of an object or a selected nearness of the object, processor(s) 106 may generate a trigger. The system may include vibrating motors grouped with or positioned near the sensors to generate vibrations that provide haptic feedback to the user. The vibrating motor associated with the sensor that generated the trigger may be programmed to vibrate at an identified intensity based on detection of an object by that sensor and/or to indicate distance of the object from that sensor and from the user. By way of example, vibration intensity may increase as the user moves toward the object and may decrease as the user moves away from the object. Likewise, vibration intensity may increase as the object moves toward the user and may decrease as the object moves away from the user. The system may thus enable the user to perceive whether an object is approaching, whether an object is stationary, whether an object blocks a path, and approximate direction of the object without reliance on sight. FIGS. 17A-17E, 18A-18C, 19A-19B, 20A-20B, 21A-21B, 22A-22C, 23A-23C, 24A-24D, and 25A-25B show example code snippets used to implement an assistive system, according to some embodiments.

Various embodiments may be implemented in single-processor or multiprocessor computer systems, including a system-on-chip (SoC) or system-in-package (SiP). An example SoC may include a clock, voltage regulator, and user input devices (e.g., touch-sensitive displays, microphones, cameras). The SoC integrates various processors, including a coprocessor (e.g., vector coprocessor), applications processor, AI processor, and neural processing unit (NPU). Additional components may include the graphics processing unit (GPU), digital signal processor (DSP), modem processor, memory, and system components and resources. The processors and components may be interconnected via an interconnection/bus, which may utilize advanced interconnect technologies such as high-performance networks-on-chip (NoCs), reconfigurable logic arrays, or bus architectures like CoreConnect or AMBA.

In some embodiments, any of the processors may function as the central processing unit (CPU), microprocessor unit (MPU), or arithmetic logic unit (ALU). The SoC may execute software programs, performing arithmetic, logical, control, and input/output (I/O) operations as specified by program instructions (e.g., processor-executable instructions, etc.). One or more of the coprocessors may be configured to assist the CPU in these operations.

The SoC may further include an input/output (I/O) module (not shown) for interfacing with external resources such as the clock, voltage regulator, user input devices, and wireless transceivers (e.g., Bluetooth, cellular transceivers). These external resources may be shared among multiple processors or cores within the SoC.

In addition to the SoC, various embodiments may be implemented in other computing systems, including those with single or multicore processors, multiple processors, or hybrid configurations that integrate different processing technologies.

All or portions of some embodiments may be implemented in the cloud or on a variety of commercially available computing devices. A server device may include a SoC or one or more processors (e.g., multi-core processor, etc.) coupled to memory, storage interfaces such as USB ports and NVMe slots, and network access ports that allow data connections through a network interface card (NIC) and a communication network (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Servers often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

Implementation examples are described in the following paragraphs. Although several implementation examples are described as example methods, other implementation examples may take the form of a computing device or data processing apparatus. The computing device or data processing apparatus may include a processing system coupled to a memory. The memory may store instructions that, upon execution by the processing system, cause the computing device or data processing apparatus to perform operations of the methods described in the following implementation examples. Further implementation examples may take the form of a computer program product comprising instructions that, upon execution by one or more processors of a computing device, cause the computing device to perform those operations. Further implementation examples may take the form of a computer-readable storage medium having stored thereon such instructions.

Example 1: An assistive system for low vision including one or more proximity sensor(s) that detects the presence, location, distance, temperature, shape, color, including material, or any other characteristic of an object without physically touching the target; and the use of haptics, sounds, pressure, temperature changes, and other sensory inputs to communicate environmental information and other information.

Example 2: An assistive system for low vision including one or more contact sensor(s) that detects the presence, location, distance, temperature, shape, color, including material, or any other characteristic of an object upon physically touching the target; and the use of haptics, sounds, pressure, temperature changes, and other sensory inputs to communicate environmental information and other information.

Example 3: The assistive system for low vision of any one of examples 1 or 2, in which the sensors used may include one or more of the following: ultrasonic distance sensors, infrared distance sensors, laser distance sensors, TOF (Time Of Flight) distance sensors, encoders, hall effect sensors, temperature sensors, light sensors, pressure sensors, acceleration sensors, gyroscopes, sound sensors, photoresistors, tilt switches, GPS (Global Positioning System), IMU (Inertial Measurement Units), hall effect sensors, and/or any other type of proximity sensor or contact sensor.

Example 4: The assistive system for low vision of any one of examples 1 or 2, in which the actuators used may include one or more of the following: haptics, sounds, other vibrations, pressure, temperature changing devices such as heaters or cooling units, and any other sensory inputs.

Example 5: The assistive system for low vision of any one of examples 1 or 2, further including: a. an image processing camera for object and text recognition, with real-time audio or haptic feedback for identified objects or text, b. a machine learning module that adapts sensor sensitivity and feedback based on user behavior, and c. wireless connectivity (e.g., Bluetooth, Wi-Fi, 5G) for integration with smartphones, smart glasses, or other assistive systems or devices.

Example 6: The assistive system for low vision of any one of examples 1 or 2, in which: a. the feedback intensity (haptic, audio, pressure) adjusts dynamically based on the proximity and nature of detected objects. b. a user-configurable customization module allows users to choose preferred feedback methods.

Example 7: The assistive system for low vision of any one of examples 1 or 2, further including: a. the ability to differentiate between moving and stationary objects and adjust feedback accordingly, b. pre-set modes for different environments (e.g., indoor, outdoor, public transportation), c. a memory module that stores frequently visited locations and provides context-aware feedback, and d. a real-time speech-to-text function that allows the system to communicate information from printed or digital text.

Example 8: The assistive system for low vision of any one of examples 1 or 2, in which: a. the system is designed for military or hazardous environments, assisting personnel in low-visibility conditions; or b. the system provides tactile signals for stealth operations where audible feedback is impractical; or c. the system includes applications for cave diving and scuba diving; or d. the system may be integrated into cars and other automobiles to allow low-vision individuals to operate them more safely; or e. the system may be integrated into drones or any other unmanned aircraft, vehicle, robot, or similar system not worn on a person's body; or f. the system may be integrated into prosthetic limbs, hearing aids, eyeglasses, hats, shoes, bracelets, watches, anklets, shirts, pants, socks, cellphones, smart watches, watches, or anything else that may be worn on a person or integrated into a person's body or carried with a person; or g. the system includes applications for use by firefighters and other emergency personnel in fires, in smoke, or other low visibility environments, and may be integrated with systems that suppress fires using sound frequencies.

Example 9: In some embodiments, a method for filtering environmental interference from distance sensor measurements in an assistive system may be performed by a computing system having one or more processors and one or more memories. The method may include collecting distance measurements from a distance sensor pointing in a given direction and storing the distance measurements from a predefined time period as a function of time in a dataset. The method may further include extrapolating the dataset to generate a predicted measurement value and receiving a new distance measurement from the distance sensor. The method may include comparing the new distance measurement to the predicted measurement value and determining whether a deviation between the new distance measurement and the predicted measurement value exceeds a threshold value. In response to determining the deviation does not exceed the threshold value, the method may include adding the new distance measurement to the dataset and communicating the new distance measurement to a user. In response to determining the deviation exceeds the threshold value, the method may include discarding the new distance measurement and communicating a most recent valid measurement to the user.

Example 10: The method of example 9, wherein the threshold value used in the environmental interference filtering method may be adjustable based on user preference.

Example 11: The method of example 9, wherein the threshold value used in the environmental interference filtering method may be approximately 3 cm.

Example 12: The method of example 9, wherein the predefined time period over which distance measurements are collected and stored may be approximately 2-3 seconds.

Example 13: The method of example 9, wherein the extrapolating may include at least one of a linear extrapolation or a polynomial curve fit to the dataset up to a fourth order polynomial.

Example 14: The method of example 9, wherein the distance measurements may be collected at a rate of 10 or more measurements per second.

Example 15: The method of example 9, wherein the method may further include determining whether a predefined number of consecutive measurements have been discarded. In response to determining the predefined number of consecutive measurements have been discarded, the method may include comparing the discarded measurements to each other. The method may further include determining whether the discarded measurements are within the threshold value of each other. In response to determining the discarded measurements are within the threshold value of each other, the method may include discarding the original dataset and initializing a new dataset using the discarded measurements as starting data points.

Example 16: In some embodiments, a method for filtering environmental interference from distance sensor measurements in an assistive system using dual distance sensors may be performed by a computing system having one or more processors and one or more memories. The method may include collecting distance measurements from a first distance sensor and a second distance sensor mounted close together and pointing in a same direction. The method may further include storing the distance measurements from the first distance sensor in a first dataset and storing the distance measurements from the second distance sensor in a second dataset. The method may include extrapolating the first dataset to generate a first predicted measurement value and extrapolating the second dataset to generate a second predicted measurement value. The method may further include receiving a first new distance measurement from the first distance sensor and a second new distance measurement from the second distance sensor. The method may include calculating a first combined average of the second new distance measurement, the second predicted measurement value, and the first predicted measurement value, and calculating a second combined average of the first new distance measurement, the second predicted measurement value, and the first predicted measurement value. The method may further include comparing the first new distance measurement to the first combined average and comparing the second new distance measurement to the second combined average to determine validity of each measurement, and communicating distance information to the user based on the validity determination

Example 17: The method of example 16, wherein the first distance sensor and the second distance sensor may be different types of distance sensors. For example, the first distance sensor may be an ultrasonic sensor, and the second distance sensor may be an infrared sensor, or vice versa.

Example 18: The method of example 16, wherein the communicating distance information to the user may include, in response to determining both the first new distance measurement and the second new distance measurement are valid, calculating an average of the first new distance measurement and the second new distance measurement and communicating the average to the user.

Example 19: The method of example 16, wherein the communicating distance information to the user may include, in response to determining only one of the first new distance measurement or the second new distance measurement is valid, communicating the valid measurement to the user.

Example 20: The method of example 16, wherein the communicating distance information to the user may include, in response to determining both the first new distance measurement and the second new distance measurement are discarded, communicating a most recent valid measurement to the user.

Example 21: A method for providing haptic feedback for navigation assistance to a visually impaired user may be performed by a computing system having a processor, a memory, and a plurality of sensors. The method may include initializing a plurality of distance sensors, the plurality of distance sensors comprising ultrasonic sensors and an infrared (IR) sensor. The method may further include detecting motion of the visually impaired user via a motion detection sensor operatively connected to the computing system. In response to detecting motion of the visually impaired user, the method may include activating the plurality of distance sensors to measure distances to one or more obstacles in an environment. The method may include generating distance data for each of the plurality of distance sensors based on the measured distances. The method may further include determining a vibration intensity for a plurality of vibrating motors based on the distance data, wherein the vibration intensity increases as the measured distance decreases. The method may include activating each vibrating motor to generate a haptic feedback output to the visually impaired user based on the corresponding determined vibration intensity.

Example 22: The method of example 21 may further include deactivating the plurality of distance sensors and the plurality of vibrating motors when no motion is detected for a predefined period, and reactivating the plurality of distance sensors and the plurality of vibrating motors upon detecting resumption of motion by the visually impaired user.

Example 23: The method of example 21, wherein generating distance data may include calculating a distance to each detected obstacle using ultrasonic pulses emitted by the ultrasonic sensors, and calculating a distance to a hand-positioned obstacle using the infrared sensor.

Example 24: The method of example 21, wherein determining the vibration intensity may include applying a predefined function to the distance data, wherein the vibration intensity is calculated as a function of the measured distance to the obstacle and a maximum vibration threshold.

Example 25: The method of example 21, wherein each sensor of the plurality of distance sensors may be mapped to a corresponding vibrating motor, such that each vibrating motor provides haptic feedback based on the distance data from the corresponding sensor.

Example 26: The method of example 21, wherein the method may further include identifying an obstacle within a critical distance threshold and triggering a maximum vibration intensity output when the obstacle is within the critical distance threshold.

Example 27: The method of example 21, wherein the method may further include performing a calibration procedure to optimize sensitivity of the plurality of distance sensors based on real-world testing, and storing calibration data to improve future distance measurement accuracy.

Example 28: The method of example 21, wherein the method may further include adjusting the vibration intensity based on feedback provided by the visually impaired user, wherein the feedback modifies a sensitivity parameter used in determining vibration intensity.

Example 29: A method for providing navigation assistance to a visually impaired user may be performed by a computing system having one or more processors, one or more memories, a motion detection sensor, a plurality of distance sensors, and a plurality of vibrating motors. The method may include detecting motion of the visually impaired user with the motion detection sensor. The method may further include activating the plurality of distance sensors to measure distances to one or more objects in response to detecting the motion. The method may include generating distance data for each distance sensor based on the measured distances. The method may further include determining vibration intensities based on the distance data, and activating each vibrating motor in response to the corresponding vibration intensity to provide haptic feedback to the visually impaired user.

Example 30: The method of example 29, wherein the method may further include deactivating the plurality of distance sensors and the plurality of vibrating motors when no motion is detected for a predefined period and reactivating the plurality of distance sensors and the plurality of vibrating motors upon detecting renewed motion.

Example 31: The method of example 29, wherein the plurality of distance sensors may include at least one ultrasonic sensor and at least one infrared sensor, and the generating of distance data may include processing ultrasonic signals and infrared signals to calculate respective distances.

Example 32: The method of example 29, wherein determining the vibration intensities may include applying a function to the distance data, the function mapping each measured distance to a vibration intensity that increases as the distance decreases.

Example 33: The method of example 29, wherein the method may further include assigning each distance sensor to a corresponding vibrating motor so that each vibrating motor provides haptic output based on distance data from the assigned distance sensor.

Example 34: The method of example 29, wherein the method may further include identifying an object that is within a threshold distance and generating a maximum vibration intensity output at a vibrating motor if the object is within the threshold distance.

Example 35: The method of example 29, wherein the method may further include performing a calibration procedure to adjust sensitivity of each distance sensor and storing calibration data in the one or more memories, wherein the generating of distance data uses the calibration data to improve accuracy.

Example 36: The method of example 29, wherein the method may further include receiving user feedback regarding perceived vibration levels and adjusting one or more parameters governing vibration intensity based on the user feedback.

Example 37: The method of example 29, wherein the motion detection sensor may include an accelerometer that transmits signals indicating user movement above a predefined threshold.

Example 38: The method of example 29, wherein activating the plurality of distance sensors may include providing power from a power source connected to the computing system and enabling sensing functions of each distance sensor.

Example 39: The method of example 29, wherein the plurality of vibrating motors may be arranged to produce distinct haptic signals at respective locations on a supporting element worn by the visually impaired user, indicating approximate directional information.

Example 40: The method of example 29, wherein the method may further include applying a filtering operation to the distance data, the filtering operation comprising one or more averaging blocks to reduce noise from each distance sensor's raw signal.

Example 41: The method of example 29, wherein the method may further include integrating the computing system with an image processing camera that captures image data, wherein the generating of distance data is supplemented by object recognition or text recognition information.

Example 42: The method of example 29, wherein each vibrating motor may be a miniature disc motor that is powered according to a pulse-width modulation signal derived from the vibration intensity.

Example 43: The method of example 29, wherein each distance sensor may be mounted to detect distance in a particular direction, providing a 360-degree coverage when combined as a plurality, and the determining of vibration intensities may include correlating each detected obstacle with one or more distance sensors positioned near that obstacle's direction.

Example 44: A computing device may have a processing system or at least one processor configured with processor-executable instructions to perform operations corresponding to any of the methods described herein.

Example 45: The computing device of example 44, wherein the computing device may have various means for performing functions corresponding to any of the methods described herein.

Example 46: A non-transitory processor-readable storage medium may have stored thereon processor-executable instructions configured to cause a processor to perform various operations corresponding to any of the methods described herein.

Example 47: A garment may be configured to house or support a computing device, non-transitory processor-readable storage medium, and/or various means for performing functions corresponding to any of the methods described herein.

The embodiments include methods of providing haptic navigation assistance to a user with a wearable assistive system, the method performed by a controller of the wearable assistive system, the method including detecting user motion with a motion sensor, activating, responsive to detecting the user motion, a plurality of distance sensors disposed at different positions on a supporting element worn by the user, acquiring, with the plurality of distance sensors, distance measurements in different sensing directions around the user, generating, with the controller, distance values from the distance measurements, mapping each distance sensor to a corresponding vibrating motor of a plurality of vibrating motors disposed on the supporting element at a body location associated with the sensing direction of the distance sensor, converting each distance value into a motor control signal for the corresponding vibrating motor, the motor control signal increasing a vibration intensity as the distance value decreases, and driving the plurality of vibrating motors with the motor control signals to produce localized haptic outputs for corresponding obstacle directions and corresponding obstacle proximities.

Some embodiments may further include detecting inactivity with the motion sensor for a predefined inactivity interval, deactivating, responsive to detecting the inactivity, the plurality of distance sensors and the plurality of vibrating motors, and reactivating, responsive to detecting resumed motion, the plurality of distance sensors and the plurality of vibrating motors. Some embodiments may further include configuring the plurality of distance sensors to include at least one ultrasonic sensor and at least one infrared sensor. Some embodiments may further include acquiring a hand-region distance measurement with the at least one infrared sensor, and generating one distance value from the hand-region distance measurement. Some embodiments may further include applying a transfer function to each distance value to generate the motor control signal, the transfer function which may include at least one of a linear mapping and an exponential mapping. Some embodiments may further include comparing each distance value with a critical distance threshold, and setting the motor control signal to a maximum vibration output responsive to the distance value being within the critical distance threshold. Some embodiments may further include executing a calibration routine for the plurality of distance sensors, storing calibration data generated by the calibration routine, and correcting the distance values with the calibration data. Some embodiments may further include receiving user feedback representing a perceived vibration response, updating a sensitivity parameter from the user feedback, and recomputing the motor control signals with the sensitivity parameter. Some embodiments may further include averaging a series of raw distance measurements from each distance sensor over a sampling interval, smoothing the series of raw distance measurements to produce the distance measurements, and generating the distance values from the smoothed distance measurements. Some embodiments may further include comparing a current distance value and a preceding distance value for one distance sensor, identifying an approaching object responsive to the current distance value being smaller than the preceding distance value by at least an approach threshold, identifying a receding object responsive to the current distance value being larger than the preceding distance value by at least a recession threshold, and modifying at least one of vibration intensity, vibration frequency, vibration duty cycle, and vibration waveform for the corresponding vibrating motor according to the approaching object or the receding object. Some embodiments may further include selecting an operating profile from a plurality of stored operating profiles, and setting, according to the operating profile, at least one of a sensing rate, a distance threshold, a filtering parameter, and a vibration-transfer function. Some embodiments may further include tracking a sequence of distance values for one detected object, classifying the detected object as moving or stationary from changes in the sequence of distance values over time, and modifying the localized haptic outputs according to the classifying. Some embodiments may further include generating each motor control signal as a pulse-width modulation signal having a duty cycle determined from the corresponding distance value. Some embodiments may further include establishing a wireless data link with at least one of a smartphone, smart glasses, a smart watch, and a smart ring, and transmitting sensor data, device status data, or user-setting data through the wireless data link. Some embodiments may further include receiving first distance measurements from a head-mounted sensor subset, receiving second distance measurements from a torso-mounted sensor subset, receiving third distance measurements from a hand-mounted sensor subset, receiving fourth distance measurements from a leg-mounted sensor subset, and receiving fifth distance measurements from a foot-mounted sensor subset.

Some embodiments may include methods of filtering environmental interference from distance measurements in a wearable assistive system, the method performed by a controller of the wearable assistive system, the method including receiving a sequence of raw distance measurements from a distance sensor directed along a sensing axis, storing a dataset of validated distance measurements from a preceding time interval, generating a predicted distance value from the dataset, receiving a current distance measurement from the distance sensor, comparing the current distance measurement with the predicted distance value, classifying the current distance measurement as a valid distance measurement responsive to the comparing indicating a deviation within a threshold value, updating the dataset with the valid distance measurement responsive to classifying the current distance measurement as the valid distance measurement, communicating the valid distance measurement responsive to classifying the current distance measurement as the valid distance measurement, and communicating a most recent validated distance measurement responsive to classifying the current distance measurement outside the threshold value.

Some embodiments may further include setting the threshold value at about 3 centimeters. Some embodiments may further include setting the preceding time interval within a range from Some embodiments may further include counting consecutive current distance measurements classified outside the threshold value, comparing the consecutive current distance measurements with each other, discarding the dataset responsive to the consecutive current distance measurements remaining within the threshold value of each other for a reset count, and initializing a replacement dataset with the consecutive current distance measurements. Some embodiments may further include maintaining communication of the most recent validated distance measurement during receipt of consecutive current distance measurements classified outside the threshold value.

Some embodiments may include methods of validating distance measurements from multiple distance sensors in a wearable assistive system, the method performed by a controller of the wearable assistive system, the method including receiving a first sequence of distance measurements from a first distance sensor and a second sequence of distance measurements from a second distance sensor, the first distance sensor and the second distance sensor having overlapping fields of view, storing a history of validated fused distance values, calculating a first reliability weight from stability of the first sequence of distance measurements and a second reliability weight from stability of the second sequence of distance measurements, generating a predicted fused distance value from the history of validated fused distance values, receiving a first current distance measurement from the first distance sensor and a second current distance measurement from the second distance sensor, combining the first current distance measurement and the second current distance measurement into a fused distance value with the first reliability weight and the second reliability weight, comparing the fused distance value with the predicted fused distance value, classifying the fused distance value as a valid fused distance value responsive to the comparing indicating a deviation within a threshold value, updating the history of validated fused distance values with the valid fused distance value responsive to classifying the fused distance value as the valid fused distance value, communicating the valid fused distance value responsive to classifying the fused distance value as the valid fused distance value, and communicating a most recent validated fused distance value responsive to classifying the fused distance value outside the threshold value.

Some embodiments may further include receiving the first sequence from an ultrasonic sensor, and receiving the second sequence from an infrared sensor. Some embodiments may further include calculating the first reliability weight from a rolling variance of recent measurements in the first sequence, and calculating the second reliability weight from a rolling variance of recent measurements in the second sequence. Some embodiments may further include generating a first predicted distance value from prior validated measurements of the first distance sensor, generating a second predicted distance value from prior validated measurements of the second distance sensor, comparing the first current distance measurement with the first predicted distance value, comparing the second current distance measurement with the second predicted distance value, classifying one of the first current distance measurement and the second current distance measurement as invalid responsive to a corresponding comparison indicating a deviation outside the threshold value, and generating the fused distance value from the other of the first current distance measurement and the second current distance measurement responsive to classifying the one current distance measurement as invalid. Some embodiments may further include generating the fused distance value as a weighted average of the first current distance measurement and the second current distance measurement responsive to classifying the first current distance measurement and the second current distance measurement as valid, and communicating the most recent validated fused distance value responsive to classifying the first current distance measurement and the second current distance measurement as invalid. Some embodiments may further include setting the first reliability weight equal to the second reliability weight.

Some embodiments may include methods of providing recognition assistance to a user with a wearable assistive system, the method performed by a controller of the wearable assistive system, the method including capturing image data with an image processing camera, processing the image data to identify a recognized item selected from text, an object, a face, an individual, and a pet, generating recognition output for the recognized item, and delivering the recognition output to the user as at least one of an audio output and a haptic output. Some embodiments may further include identifying the recognized item as text, converting the text into speech data, and rendering the speech data as the audio output. Some embodiments may further include receiving distance measurements from a plurality of distance sensors, determining a direction of the recognized item from the image data and the distance measurements, selecting one vibrating motor from a plurality of vibrating motors according to the direction, and driving the one vibrating motor with a haptic pattern representing the recognized item. Some embodiments may further include identifying the recognized item as at least one of a face, an individual, and a pet, retrieving identity data associated with the recognized item from a stored library, and delivering the identity data as the recognition output. Some embodiments may further include receiving a user preference defining an output modality, selecting the audio output or the haptic output according to the user preference, and adjusting an output intensity according to the user preference. Some embodiments may further include storing route data or item data associated with prior user interactions, matching the recognized item or a current environment to the route data or the item data, and generating context-enhanced recognition output from the matching. Some embodiments may further include establishing a wireless data link with an external device, and transmitting the recognition output through the wireless data link.

Some embodiments may include methods of providing hand-based haptic navigation assistance to a user with a wearable assistive system, the method performed by a controller of the wearable assistive system, the method including receiving forward distance measurements from a forward subset of hand-mounted distance sensors directed away from a wrist of the user at different angles, receiving left-side distance measurements from a left-side hand-mounted distance sensor, receiving right-side distance measurements from a right-side hand-mounted distance sensor, receiving upward distance measurements from an upward hand-mounted distance sensor, generating respective motor control signals from the forward distance measurements, the left-side distance measurements, the right-side distance measurements, and the upward distance measurements, and driving respective hand-mounted vibrating motors with the respective motor control signals to produce haptic outputs for obstacle direction and obstacle proximity adjacent the hand. Some embodiments may further include receiving first forward distance measurements from a first forward hand-mounted distance sensor, receiving second forward distance measurements from a second forward hand-mounted distance sensor, and receiving third forward distance measurements from a third forward hand-mounted distance sensor. Some embodiments may further include receiving the first forward distance measurements, the second forward distance measurements, and the third forward distance measurements while the first forward hand-mounted distance sensor, the second forward hand-mounted distance sensor, and the third forward hand-mounted distance sensor remain separated by angles within a range from 0 degrees to 120 degrees. Some embodiments may further include receiving the first forward distance measurements, the second forward distance measurements, and the third forward distance measurements while the first forward hand-mounted distance sensor, the second forward hand-mounted distance sensor, and the third forward hand-mounted distance sensor remain separated by angles within a range from 1 degree to 90 degrees. Some embodiments may further include receiving the first forward distance measurements, the second forward distance measurements, and the third forward distance measurements while the first forward hand-mounted distance sensor, the second forward hand-mounted distance sensor, and the third forward hand-mounted distance sensor remain separated by angles within a range from 5 degrees to 45 degrees. Some embodiments may further include receiving overlapping forward distance measurements from two hand-mounted distance sensors having overlapping forward fields, validating one overlapping forward distance measurement with another overlapping forward distance measurement before generating one motor control signal, and generating the one motor control signal from the validated overlapping forward distance measurements. Some embodiments may further include grouping at least two hand-mounted distance sensors into one directional group, combining distance measurements from the one directional group into one group distance value, and driving one hand-mounted vibrating motor according to the one group distance value.

Further embodiments may include a computing device having a processor configured with processor-executable instructions to perform various operations corresponding to the methods discussed above. Further embodiments may include a computing device having various means for performing functions corresponding to the method operations discussed above. Further embodiments may include a non-transitory processor-readable storage medium having stored thereon processor-executable instructions configured to cause a processor to perform various operations corresponding to the method operations discussed above.

The assistive system gives a low-vision user a practical way to sense nearby obstacles, direction, and movement through touch rather than sight. Distance sensors placed on a garment or other supporting element may watch the space around the user, and paired vibrating motors notify the user where an obstacle sits and how near that obstacle has moved. A motion-triggered control scheme may reduce idle activity and power draw, and a prediction-based filtering process rejects stray sensor readings from noise or reflective surfaces. As such, the assistive system may provide clearer navigation support during daily travel and indoor movement without reliance on a cane alone.

The assistive system may provide a coordinated control architecture (rather than from a mere collection of known sensors and motors) and couples motion-triggered activation, sensor-to-motor spatial mapping, distance-scaled haptic output, predictive validation of incoming measurements, and dual-sensor cross-check logic within one control path. That control path may reduce false alerts and idle operation through a defined interaction among sensing, validation, and actuation steps. Each feature may support the others, and the combined structure may yield a directional haptic guidance function with lower interference response and lower power use.

The assistive system may enhance the performance and functionality of a computing system and a network by limiting sensor acquisition, processing operations, memory updates, and outbound communications to intervals that carry actionable data. Motion-triggered activation may reduce idle polling, and predictive filtering may block invalid measurements before those measurements reach later control stages or remote devices. Sensor-to-motor mapping may permit direct local actuation with shorter control paths and lower response delay. Where a user device or remote service participates, the same event-driven control path may reduce uplink traffic and preserve network bandwidth for validated measurements and user-relevant events.

The system may also address excessive sensor traffic and motor vibration updates that increase latency and energy consumption in a wearable assistive system. The computing/processing system may activate the distance sensor upon motion detection and suspend it after a no-motion interval. The processing system may form a predicted measurement from a valid dataset and may reject a new measurement that exceeds a threshold. The processing system may map each distance sensor to a single vibrating motor and issue one local control signal per valid measurement. Prototype tests may show a significant drop in sensor memory writes and bus transfers, as measured by firmware counters and logic-analyzer traces on the processor bus. Prototype tests may show a reduction in distance-sensor-to-vibrating-motor latency and a reduction in energy per hour, as measured with processor timestamp logs and a shunt-current meter on the power rail. Those effects follow from motion-gated distance sensor reads together with threshold-based rejection and one-hop vibrating motor control.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the pseudo code are provided merely as illustrative examples and are not intended to require or imply that the blocks of the various aspects must be performed in the order presented. As may be appreciated by one of skill in the art the order of blocks in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic blocks described in connection with the aspects disclosed herein may be implemented as electronic hardware, computer software, or combinations of both. To clearly illustrate the interchangeability of hardware and software, various components, blocks, modules, circuits, and blocks have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the various embodiments is not intended to be limited to the aspects shown herein but is to be accorded the widest scope consistent with the following claims and the principles and novel features disclosed herein.

What is claimed is:

1. An assistive system for providing haptic feedback for navigation assistance to a visually impaired user, the system comprising:
a computing system including a processor and a memory;
a plurality of distance sensors operatively coupled to the computing system, the plurality of distance sensors comprising an ultrasonic sensor and an infrared (IR) sensor;
a motion detection sensor operatively coupled to the computing system and configured to detect motion of the visually impaired user; and
a plurality of vibrating motors operatively coupled to the computing system,
wherein the processor is configured to:
activate, in response to detecting motion of the visually impaired user via the motion detection sensor, the plurality of distance sensors to measure distances to one or more obstacles in an environment;
generate distance data for each of the plurality of distance sensors based on the measured distances;
determine a vibration intensity for each of the plurality of vibrating motors based on the distance data, wherein the vibration intensity increases as the measured distance decreases; and
activate each vibrating motor to generate a haptic feedback output to the visually impaired user based on the corresponding determined vibration intensity.

2. The system of claim 1, wherein the processor is further configured to:
deactivate the plurality of distance sensors and the plurality of vibrating motors when no motion is detected for a predefined period; and
reactivate the plurality of distance sensors and the plurality of vibrating motors upon detecting resumption of motion by the visually impaired user.

3. The system of claim 1, wherein the processor is configured to generate distance data by:
calculating a distance to each detected obstacle using ultrasonic pulses emitted by the ultrasonic sensor; and
calculating a distance to a hand-positioned obstacle using the infrared sensor.

4. The system of claim 1, wherein each sensor of the plurality of distance sensors is mapped to a corresponding vibrating motor such that each vibrating motor provides haptic feedback based on the distance data from the corresponding sensor.

5. The system of claim 1, wherein the processor is further configured to:
identify an obstacle within a critical distance threshold; and
trigger a maximum vibration intensity output when the obstacle is within the critical distance threshold.

6. The system of claim 1, wherein the processor is further configured to:
adjust the vibration intensity based on feedback provided by the visually impaired user,
wherein the feedback modifies a sensitivity parameter used in determining vibration intensity.

7. A non-transitory processor-readable storage medium having stored thereon processor-executable instructions configured to cause a processor to perform operations comprising:
activating, in response to detecting motion of a visually impaired user via a motion detection sensor, a plurality of distance sensors to measure distances to one or more obstacles in an environment, the plurality of distance sensors comprising ultrasonic sensor and an infrared (IR) sensor;
generating distance data for each of the plurality of distance sensors based on the measured distances;
determining a vibration intensity for each of a plurality of vibrating motors based on the distance data, wherein the vibration intensity increases as the measured distance decreases; and
activating each vibrating motor to generate a haptic feedback output to the visually impaired user based on the corresponding determined vibration intensity.

8. The non-transitory processor-readable storage medium of claim 7, wherein the stored processor-executable instructions are configured to cause the processor to perform operations further comprising:
deactivating the plurality of distance sensors and the plurality of vibrating motors when no motion is detected for a predefined period; and
reactivating the plurality of distance sensors and the plurality of vibrating motors upon detecting resumption of motion by the visually impaired user.

9. The non-transitory processor-readable storage medium of claim 7, wherein the stored processor-executable instructions are configured to cause the processor to perform operations such that generating distance data comprises:
calculating a distance to each detected obstacle using ultrasonic pulses emitted by the ultrasonic sensor; and
calculating a distance to a hand-positioned obstacle using the infrared sensor.

10. The non-transitory processor-readable storage medium of claim 7, wherein each sensor of the plurality of distance sensors is mapped to a corresponding vibrating motor such that each vibrating motor provides haptic feedback based on the distance data from the corresponding sensor.

11. The non-transitory processor-readable storage medium of claim 7, wherein the stored processor-executable instructions are configured to cause the processor to perform operations further comprising:
identifying an obstacle within a critical distance threshold; and
triggering a maximum vibration intensity output when the obstacle is within the critical distance threshold.

12. A method for providing navigation assistance to a visually impaired user, the method comprising:
detecting motion of a user based on data from a motion detection sensor;
activating a plurality of distance sensors to measure distances to one or more objects in response to detecting the motion;
generating distance data for each distance sensor based on the distances measured;
determining a vibration intensity based on the distances measured; and
activating a vibrating motor to vibrate to the vibration intensity to provide haptic feedback to the user.

13. The method of claim 12, further comprising deactivating the plurality of distance sensors and the vibrating motor when no motion is detected for a predefined period and reactivating the plurality of distance sensors and the vibrating motor upon detecting renewed motion.

14. The method of claim 12, wherein:
the plurality of distance sensors includes at least one ultrasonic sensor and at least one infrared sensor; and
generating the distance data comprises processing ultrasonic signals and infrared signals.

15. The method of claim 12, wherein determining the vibration intensity comprises applying a function to the distances measured, the function mapping each distance measured to a vibration intensity that increases as the distance decreases.

16. The method of claim 12, wherein the vibrating motor is one of a plurality of vibrating motors, the method further comprising assigning each distance sensor to a corresponding vibrating motor so that each vibrating motor provides haptic output based on distance data from the assigned distance sensor.

17. The method of claim 12, further comprising identifying an object that is within a threshold distance and generating a maximum vibration intensity output at the vibrating motor if the object is within the threshold distance.

18. The method of claim 12, further comprising performing a calibration procedure to adjust sensitivity of each distance sensor and storing calibration data in one or more memories, wherein the generating of distance data uses the calibration data to improve accuracy.

19. The method of claim 12, further comprising:
collecting distance measurements over a predefined time period from a distance sensor pointing in an identified direction;
storing the distance measurements as a function of time in a dataset;
extrapolating the dataset to generate a predicted measurement value;
receiving a new distance measurement from the distance sensor;
comparing the new distance measurement to the predicted measurement value;
determining whether a deviation between the new distance measurement and the predicted measurement value exceeds a threshold value;
in response to determining the deviation does not exceed the threshold value, adding the new distance measurement to the dataset and communicating the new distance measurement to a user; and
in response to determining the deviation exceeds the threshold value, discarding the new distance measurement and communicating a most recent valid measurement to the user.

20. The method of claim 12, further comprising:
collecting distance measurements from a first distance sensor and a second distance sensor, the first distance sensor and the second distance sensor positioned proximate to each other and oriented to point in a same direction;
storing the distance measurements from the first distance sensor in a first dataset and storing the distance measurements from the second distance sensor in a second dataset;
extrapolating the first dataset to generate a first predicted measurement value and extrapolating the second dataset to generate a second predicted measurement value;
receiving a first new distance measurement from the first distance sensor and a second new distance measurement from the second distance sensor;
calculating a first combined average of the second new distance measurement, the second predicted measurement value, and the first predicted measurement value;
calculating a second combined average of the first new distance measurement, the second predicted measurement value, and the first predicted measurement value;
comparing the first new distance measurement to the first combined average and comparing the second new distance measurement to the second combined average to determine validity of each measurement; and
communicating distance information to the user based on the validity determination.
